(19) United States
(12) Patent Application Publication
(10) Pub. No.: US 2022/0061316 A1
(43) Pub. Date: Mar. 3, 2022

(54) HUMIDITY ACTIVATED COMPOSITIONS FOR RELEASE OF ANTIMICROBIALS

(71) Applicant: Hazel Technologies, Inc., Chicago, IL (US)

(72) Inventors: Adam Truett Preslar, London (GB); Aidan R. Mouat, Chicago, IL (US)

(73) Assignee: Hazel Technologies, Inc., Chicago, IL (US)

(21) Appl. No.: 17/299,734

(22) PCT Filed: Dec. 6, 2019
(86) PCT No.: PCT/US2019/065049

§ 371 Date: Jun. 3, 2021

Related U.S. Application Data
(60) Provisional application No. 62/863,857, filed on Jun. 19, 2019.
(60) Provisional application No. 62/827,484, filed on Apr. 1, 2019.
(60) Provisional application No. 62/777,069, filed on Dec. 7, 2018.

(51) Int. Cl. A01N 25/08; A01N 31/16; A01N 25/04

(52) U.S. Cl. CPC A01N 25/08; A01N 25/04; A01N 31/16

(57) ABSTRACT

Compositions for humidity activated release of antimicrobials, and associated methods, are generally provided. Certain aspects are related to compositions comprising delivery materials (e.g., silica-based delivery materials) and antimicrobials. The delivery material and the antimicrobial can be associated with each other such that when humidity is introduced to the composition, at least a portion of the antimicrobial is released from the composition. Methods of releasing antimicrobials from compositions are also provided. Certain methods comprise allowing antimicrobial to be released from a composition such that the antimicrobial suppresses the actions or adverse effects of pathogens or pests.

### RELATED APPLICATIONS

This application claims priority under 35 U.S.C. § 119(e) to U.S. Provisional Application No. 62/777,069, filed on Dec. 7, 2018, and entitled “Humidity Activated Compositions for Release of Antimicrobials,” U.S. Provisional No. 62/827,484, filed on Apr. 1, 2019, and entitled “Humidity Activated Compositions for Release of Antimicrobials,” and U.S. Provisional Application No. 62/863,857, filed on Jun. 19, 2019, and entitled “Humidity Activated Compositions for Release of Antimicrobials,” each of which is incorporated herein by reference in its entirety for all purposes.

### SUMMARY

Compositions for humidity activated release of antimicrobials, and associated methods, are generally provided. The subject matter of the present invention involves, in some cases, interrelated products, alternative solutions to a particular problem, and/or a plurality of different uses of one or more systems and/or articles.

Certain aspects are related to compositions. In some embodiments, the composition comprises a silica-based delivery material; and antimicrobial present in the silica-based delivery material in an amount of at least about 0.001 wt % versus the total weight of the silica-based delivery material and the antimicrobial, wherein the antimicrobial is associated with the silica-based delivery material such that when humidity is introduced to the composition, at least a portion of the antimicrobial is released from the composition.

In some embodiments, the composition comprises a silica-based delivery material; and antimicrobial present in the silica-based delivery material in an amount of at least about 0.001 wt % versus the weight of the composition, wherein the antimicrobial is associated with the silica-based delivery material such that when humidity is introduced to the composition, at least a portion of the antimicrobial is released from the composition.

The composition comprises, in certain embodiments, silica; and antimicrobial present in the silica in an amount of at least about 0.001 wt % versus the total weight of the silica and the antimicrobial, wherein the antimicrobial is associated with the silica such that when humidity is introduced to the composition, at least a portion of the antimicrobial is released from the composition.

In certain embodiments, the composition comprises silica; and antimicrobial present in the silica in an amount of at least about 0.001 wt % versus the total weight of the composition, wherein the antimicrobial is associated with the silica such that when humidity is introduced to the composition, at least a portion of the antimicrobial is released from the composition.

Antimicrobial composites are provided, according to certain embodiments. In some embodiments, the antimicrobial composite comprises a composition comprising: silica; and antimicrobial; and a dispersion medium, wherein the antimicrobial is present in an amount of at least about 0.001 wt % versus the total weight of the antimicrobial composite, and wherein the antimicrobial is associated with the silica such that when humidity is introduced to the composition, at least a portion of the antimicrobial is released from the composition.

In certain embodiments, the antimicrobial composite comprises a composition comprising: a silica-based delivery material; and antimicrobial; and a dispersion medium, wherein the antimicrobial is present in an amount of at least about 0.001 wt % versus the total weight of the antimicrobial composite, and wherein the antimicrobial is associated with the silica-based delivery material such that when humidity is introduced to the composition, at least a portion of the antimicrobial is released from the composition.

In some embodiments, the antimicrobial composite comprises antimicrobial present in the antimicrobial composite in an amount of at least about 0.001 wt % versus the total weight of the antimicrobial composite, wherein the antimicrobial is associated with at least a portion of the antimicrobial composite such that when humidity is introduced to the antimicrobial composite, at least a portion of the antimicrobial is released from the antimicrobial composite.

The antimicrobial composite comprises, in some embodiments, delivery material present in the antimicrobial composite in an amount of at least about 20 wt % versus the total weight of the antimicrobial composite; antimicrobial associated with the delivery material.

The antimicrobial composite comprises, in certain embodiments, delivery material present in the antimicrobial composite in an amount of up to about 45 wt % versus the total weight of the antimicrobial composite; antimicrobial associated with the delivery material.

Certain aspects are related to packaging inserts. In some embodiments, the packaging insert comprises antimicrobial present in the packaging insert in an amount of at least about 0.001 wt % versus the total weight of the packaging insert, wherein the antimicrobial is associated with at least a portion of the packaging insert such that when humidity is introduced to the packaging insert, at least a portion of the antimicrobial is released from the packaging insert.

Methods are also provided, in accordance with some embodiments. In certain embodiments, the method comprises exposing a composition comprising an antimicrobial stored in a silica-based delivery material to humidity such that the antimicrobial is released from the composition.

In some embodiments, the method comprises exposing an antimicrobial composite comprising an antimicrobial to humidity such that the antimicrobial is released from the antimicrobial composite, wherein the antimicrobial composite comprises: a dispersion medium; and a silica-based delivery material dispersed in the dispersion medium, wherein the antimicrobial is stored in the silica-based delivery material prior to release.

The method comprises, according to certain embodiments, exposing an antimicrobial composite comprising an antimicrobial to humidity such that the antimicrobial is released from the antimicrobial composite, wherein the antimicrobial composite comprises: a solid material; and silica dispersed in the dispersion medium, wherein the antimicrobial is stored in the silica prior to release.

In some embodiments, the method comprises exposing a package comprising produce and a composition, the composition comprising an antimicrobial, to humidity such that the antimicrobial is released from the composition.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are not intended to limit the scope of the invention. These figures are schematic and not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 illustrates a non-limiting example of a magnified antimicrobial composite comprising matrices and fibrous material of a dispersion medium, according to some embodiments; and

FIG. 2 illustrates a non-limiting example of a packaging insert, according to some embodiments.

### DETAILED DESCRIPTION

Compositions for humidity activated release of antimicrobials, and associated methods, are generally provided. In some embodiments, a matrix is provided comprising a delivery material and at least one antimicrobial. In some embodiments, a composition is provided comprising a silica-based delivery material and at least one antimicrobial. In some embodiments, one or more antimicrobials may be stored in and released from the delivery materials discussed herein. In some embodiments, a humidity activated antimicrobial composite is provided comprising a dispersion medium and a matrix dispersed into the dispersion medium. In some embodiments, the antimicrobial comprises clove oil or clove extract.

The compositions may be useful for applications in at least one of agriculture, pest control, odor control, and food preservation. In some embodiments, the compositions and the use of compositions as described herein relate to the release or controlled-release delivery of vapor-phase or gas-phase antimicrobials. Additionally, one or more antimicrobials as used herein can mean one antimicrobial or more than one antimicrobial (e.g., two antimicrobials, three antimicrobials, or more). A “vapor-phase antimicrobial” or “gas-phase antimicrobial” is an antimicrobial that is in the vapor-phase or gas phase, respectively, at the desired conditions (e.g., ambient room temperature (about 21° C.-25° C.) and atmospheric pressure).

In a non-limiting embodiment, a delivery material is an adsorbent material with calibrated or otherwise chosen affinity for antimicrobial. One of ordinary skill in the art would understand that a delivery material (e.g., in a composition or antimicrobial composite) refers to the volume of material with which the antimicrobial is associated prior to its release. For example, in embodiments in which the antimicrobial is adsorbed to silica particles dispersed in an inert solid, the delivery material refers to the silica particles, but not the inert solid, because the antimicrobial is associated with the silica (via adsorption) but is not associated with the inert solid. In some embodiments, the delivery material is a solid material. In some embodiments, the delivery material is a solid powder material. In some embodiments, when a delivery material has been charged with at least one antimicrobial, the combination of the delivery material and the antimicrobial may be referred to herein as a matrix (and multiple such combinations, as matrices). In a non-limiting embodiment, the matrix is a silica-based material to which an antimicrobial is bound by physicochemical or non-covalent means. In an embodiment, a matrix comprises a silica-based delivery material and at least one antimicrobial. In an embodiment, a matrix comprises a delivery material and at least one antimicrobial, the at least one antimicrobial contained within the delivery material. In an embodiment, a matrix comprises a delivery material and at least one antimicrobial, the at least one antimicrobial adsorbed on one or more surfaces of the delivery material. In an embodiment, a matrix comprises a silica-based delivery material and at least one antimicrobial, the at least one antimicrobial contained within the silica-based delivery material. In an embodiment, a matrix comprises a delivery material and at least one antimicrobial, the at least one antimicrobial adsorbed by the delivery material. In an embodiment, a matrix comprises a silica-based delivery material and at least one antimicrobial, the at least one antimicrobial adsorbed by the silica-based delivery material. In a non-limiting embodiment, a matrix consists essentially of a delivery material and at least one antimicrobial. In a non-limiting embodiment, a matrix consists essentially of a silica-based delivery material and at least one antimicrobial. In some embodiments, the antimicrobial comprises clove oil. In a non-limiting embodiment, the antimicrobial consists essentially of clove oil.

In some embodiments, the matrix comprises a single antimicrobial. In other embodiments, the matrix comprises more than one antimicrobial, for example, two different antimicrobials, three different antimicrobials, four different antimicrobials, or more. In some embodiments, when determining the weight percent of antimicrobial in the matrix, the total weight of all antimicrobials present in the matrix is considered in determining the weight percent of antimicrobial and the weight or mass of the matrices described herein. In some embodiments, when determining the weight percent of antimicrobial in the matrix, the total weight of all antimicrobials present in and intended to be subsequently released from the matrix is considered in determining the weight percent of antimicrobial and the weight of the matrices described herein.

In an embodiment, all delivery materials charged with and subsequently releasing antimicrobials are considered the delivery material for determining the weight percent of antimicrobial and the weight or mass of a matrix as described herein. In an embodiment, all silica-based materials charged with and subsequently releasing antimicrobials are considered the delivery material for determining the weight percent of antimicrobial and the weight or mass of a matrix as described herein.

In some embodiments, the weight percent of antimicrobial is indicated as the weight percent of antimicrobial versus the total weight of the matrix, (e.g., the total weight of the matrix being the total weight of the delivery material and antimicrobial). In some embodiments, the antimicrobial of the matrix may comprise a single antimicrobial. In other embodiments, the antimicrobial of the matrix may comprise more than one antimicrobial, for example, two antimicrobials, three antimicrobials, four antimicrobials, or more. The matrix may comprise any suitable amount of antimicrobial. In some cases, antimicrobial is present in the matrix in at least about 0.001 wt %, at least about 0.01 wt %, at least about 0.3 wt %, at least about 0.1 wt %, at least about 0.5 wt %, at least about 1 wt %, at least about 1.5 wt %, at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, or more, versus the total weight of matrix (e.g., the total weight of the delivery material and antimicrobial). In other words, in non-limiting embodiments, the matrix comprises antimicrobial in a weight percent of at least about 0.001 wt %, at least about 0.01 wt %, at least about 0.3 wt %, at least about 0.05 wt %, at least about 0.1 wt %, at least about 0.5 wt %, at least about 1 wt %, at least about 1.5 wt %, at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, or more, of the total weight of the matrix (e.g., the total weight of the delivery material and antimicrobial). In some embodiments, antimicrobial is present in the matrix at between about 0.001 wt % and about 3 wt %, between about 0.03 wt % and about 0.1 wt %, between about 0.03 wt % and about 0.5 wt %, between about 0.03 wt % and about 1 wt %, between about 0.03 wt % and about 1.5 wt %, between about 0.03 wt % and about 3 wt %, between about 0.05 wt % and about 1.5 wt %, between about 0.05 wt % and about 3 wt %, between about 0.5 wt % and about 5 wt %, between about 1 wt % and about 5 wt %, between about 2 wt % and about 10 wt %, between about 0.001 wt % and about 20 wt %, between about 0.05 wt % and about 20 wt %, between about 0.1 wt % and about 20 wt %, between about 0.5 wt % and about 20 wt %, between about 1 wt % and about 20 wt %, between about 1.5 wt % and about 20 wt %, between about 2 wt % and about 20 wt %, between about 4 wt % and about 20 wt %, between about 5 wt % and about 20 wt %, between about 7 wt % and about 20 wt %, between about 10 wt % and about 20 wt %, between about 2 wt % and about 7 wt %, between about 2 wt % and about 10 wt %, between about 2 wt % and about 15 wt %, between about 4 wt % and about 10 wt %, between about 4 wt % and about 15 wt %, or between about 7 wt % and about 15 wt %, versus the total weight of the matrix (e.g., the total weight of the delivery material and antimicrobial). In some embodiments, where the delivery material is a silica-based delivery material, the weight percent of antimicrobial means the weight percent of antimicrobial versus the total weight of the matrix (e.g., the total weight of the matrix being the total weight of the silica-base delivery material and antimicrobial). In a non-limiting embodiment, the weight percent of antimicrobial means the weight percent of antimicrobial versus the total weight of the matrix, the matrix being a silica-based delivery material charged with antimicrobial, where the total weight of the matrix is the total weight of the silica-based delivery material and antimicrobial. In an embodiment, the antimicrobial comprises clove oil or clove extract. In an embodiment, the antimicrobial comprises one or more of clove oil, vanilla extract, and lemongrass oil. In an embodiment, the antimicrobial comprises clove oil, vanilla extract, and lemongrass oil. In an embodiment, the antimicrobial is selected from the group consisting of clove oil, clove extract, vanilla extract, lemongrass oil, and combinations thereof.

In some embodiments, the weight percent of antimicrobial is indicated as the weight percent of antimicrobial versus the total weight of the composition, (e.g., comprising the delivery material and the antimicrobial). In some embodiments, the antimicrobial may comprise a single antimicrobial. In other embodiments, the antimicrobial of may comprise more than one antimicrobial, for example, two antimicrobials, three antimicrobials, four antimicrobials, or more. The composition may comprise any suitable amount of antimicrobial. In some cases, antimicrobial is present in the composition in at least about 0.001 wt %, at least about 0.01 wt %, at least about 0.3 wt %, at least about 0.1 wt %, at least about 0.5 wt %, at least about 1 wt %, at least about 1.5 wt %, at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, or more, versus the total weight of composition (e.g., comprising the delivery material and the antimicrobial). In other words, in non-limiting embodiments, the composition comprises antimicrobial in a weight percent of at least about 0.001 wt %, at least about 0.01 wt %, at least about 0.05 wt %, at least about 0.1 wt %, at least about 0.5 wt %, at least about 1 wt %, at least about 1.5 wt %, at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, or more, of the total weight of the composition (e.g., comprising the delivery material and the antimicrobial). In some embodiments, antimicrobial is present in the composition at between about 0.001 wt % and about 3 wt %, between about 0.03 wt % and about 0.1 wt %, between about 0.03 wt % and about 0.5 wt %, between about 0.03 wt % and about 1 wt %, between about 0.03 wt % and about 1.5 wt %, between about 0.03 wt % and about 3 wt %, between about 0.05 wt % and about 1.5 wt %, between about 0.05 wt % and about 3 wt %, between about 0.5 wt % and about 5 wt %, between about 1 wt % and about 5 wt %, between about 2 wt % and about 10 wt %, between about 0.001 wt % and about 20 wt %, between about 0.05 wt % and about 20 wt %, between about 0.1 wt % and about 20 wt %, between about 0.5 wt % and about 20 wt %, between about 1 wt % and about 20 wt %, between about 1.5 wt % and about 20 wt %, between about 2 wt % and about 20 wt %, between about 4 wt % and about 20 wt %, between about 5 wt % and about 20 wt %, between about 7 wt % and about 20 wt %, between about 10 wt % and about 20 wt %, between about 2 wt % and about 7 wt %, between about 2 wt % and about 10 wt %, between about 2 wt % and about 15 wt %, between about 4 wt % and about 10 wt %, between about 4 wt % and about 15 wt %, or between about 7 wt % and about 15 wt %, versus the total weight of the composition (e.g., comprising the delivery material and the antimicrobial). In some embodiments, where the delivery material is a silica-based delivery material, the weight percent of antimicrobial means the weight percent of antimicrobial versus the total weight of the composition (e.g., comprising the silica-base delivery material and antimicrobial). In a non-limiting embodiment, the weight percent of antimicrobial means the weight percent of antimicrobial versus the total weight of the composition, the composition comprising a silica-based delivery material charged with antimicrobial. In an embodiment, the antimicrobial comprises clove oil or clove extract. In an embodiment, the antimicrobial comprises one or more of clove oil, vanilla extract, and lemongrass oil. In an embodiment, the antimicrobial comprises clove oil, vanilla extract, and lemongrass oil. In an embodiment, the antimicrobial is selected from the group consisting of clove oil, clove extract, vanilla extract, lemongrass oil, and combinations thereof.

Matrices as described herein may be mixed with or dispersed in a dispersion medium. In some embodiments, a dispersion medium is a solid material. In some embodiments, a dispersion medium is a pulp. In some embodiments, a dispersion medium comprises a pulp. In some embodiments, a dispersion medium is a fibrous material. In some embodiments, a dispersion medium comprises a fibrous material. In some embodiments, the matrix is dispersed homogeneously in the dispersion medium. In some embodiments, the matrix is coated on the surface of the dispersion medium. In some embodiments, the matrix is included as heterogeneous domains within the dispersion medium. In some embodiments, the dispersion medium comprises a polymeric material. In some embodiments, the dispersion medium consists essentially of a polymeric material. In some embodiments, the polymeric material comprises a biopolymer. In some embodiments, the polymeric material consists essentially of a biopolymer. In some embodiments, the polymeric material comprises a fibrous material. In some embodiments, the polymeric material consists essentially of a fibrous material. In some embodiments the dispersion medium comprises cellulose. In some embodiments, the dispersion medium consists essentially of cellulose. In some embodiments, the polymeric material comprises cellulose. In some embodiments, the polymeric material consists essentially of cellulose. In some embodiments, the fibrous material comprises cellulose. In some embodiments, the fibrous material consists essentially of cellulose. In some embodiments, the fibrous material comprises wood pulp and/or wood fiber. In some embodiments, the fibrous material consists essentially of wood pulp. In some embodiments, the fibrous material consists essentially of wood fiber.

Examples of dispersion mediums include, but are not limited to, chitosan, nylon, acrylonitrile butadiene styrene (ABS), polyamides, polyimines, polycarbonates, alginate, and polyacrylates including poly(methyl methacrylate). In some embodiments, the dispersion medium is wettable. As used herein, a material is considered to be wettable when the contact angle formed between the material and a water droplet, when in air at 25° C. and atmospheric pressure, is less than 80°. In some embodiments, the contact angle between a water droplet and the wettable material can be less than 60°, less than 45°, less than 30°, or less. In some embodiments, the dispersion medium is water-absorbent. In some embodiments, the dispersion medium is both wettable and water-absorbent. In some embodiments, the combination of matrix and dispersion medium forms a paper, packing material, film, or plastic. In some embodiments, the combination of a matrix and dispersion medium, and particularly when a matrix is mixed with or dispersed in a dispersion medium, may be referred to herein as an antimicrobial composite. In some embodiments, dispersion medium is present in the antimicrobial composite in at least about 50 wt %, at least about 55 wt %, at least about 60 wt %, at least about 62 wt %, at least about 65 wt %, at least about 70 wt %, at least about 75 wt %, at least about 80 wt %, at least about 85 wt %, at least about 90 wt %, at least about 95 wt %, or at least about 99 wt % versus the total weight of antimicrobial composite (e.g., the total weight of the matrix and the dispersion medium). In some embodiments, dispersion medium is present in the antimicrobial composite in at between about 50 wt % and about 99 wt %, between about 55 wt % and about 99 wt %, between about 60 wt % and about 99 wt %, between about 62 wt % and about 99 wt %, between about 65 wt % and about 99 wt %, between about 70 wt % and about 99 wt %, between about 75 wt % and about 99 wt %, between about 50 wt % about 75 wt %, between about 55 wt % and about 75 wt %, between about 60 wt % and about 75 wt %, or between about 60 wt % and about 70 wt % versus the total weight of antimicrobial composite (e.g., the total weight of the matrix and the dispersion medium). In some embodiments, dispersion medium is present in the antimicrobial composite in at least about 50 wt %, at least about 55 wt %, at least about 60 wt %, at least about 62 wt %, at least about 65 wt %, at least about 70 wt %, at least about 75 wt %, at least about 80 wt %, at least about 85 wt %, at least about 90 wt %, at least about 95 wt %, or at least about 99 wt % versus the total weight of antimicrobial composite (e.g., comprising the matrix and the dispersion medium). In some embodiments, dispersion medium is present in the antimicrobial composite in at between about 50 wt % and about 99 wt %, between about 55 wt % and about 99 wt %, between about 60 wt % and about 99 wt %, between about 62 wt % and about 99 wt %, between about 65 wt % and about 99 wt %, between about 70 wt % and about 99 wt %, between about 75 wt % and about 99 wt %, between about 50 wt % about 75 wt %, between about 55 wt % and about 75 wt %, between about 60 wt % and about 75 wt %, or between about 60 wt % and about 70 wt % versus the total weight of antimicrobial composite (e.g., comprising the matrix and the dispersion medium).

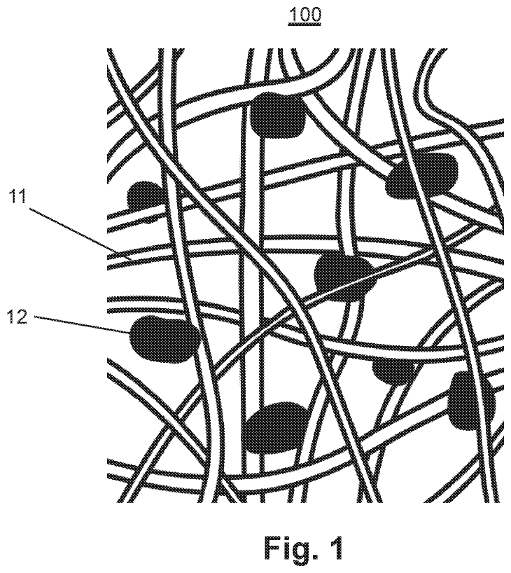

FIG. 1 illustrates a non-limiting example of a magnified antimicrobial composite 100 comprising a matrices 12 and fibrous material 11 of a dispersion medium. In some embodiments, the antimicrobial composite comprises a paper. In some embodiments, the antimicrobial composite is a paper. In some embodiments, the antimicrobial composite comprises a film. In some embodiments, the antimicrobial composite is a film. In some embodiments, the antimicrobial composite comprises a polyethylene film. In some embodiments, the antimicrobial composite is a polyethylene film. In some embodiments, the antimicrobial composite comprises a plastic. In some embodiments, the antimicrobial composite is a plastic. An antimicrobial composite, (for example, a paper or film) has the advantage of being easily proces sable, such as in a roll-to-roll processing technique, can readily be manufactured in bulk using conventional paper-making techniques, printable for commercial dress, and can be sized to fit into a wide variety of packaging, including but not limited to pallets, boxes, cases, punnets, flow packs, or clamshells.

In non-limiting embodiments, the antimicrobial composite comprises matrix in a weight percent of up to about 2 wt %, up to about 3 wt %, up to about 4 wt %, up to about 5 wt %, up to about 6 wt %, up to about 7 wt %, up to about 8 wt %, up to about 9 wt %, up to about 10 wt %, up to about 15 wt %, up to about 20 wt %, up to about 25 wt %, up to about 30 wt %, up to about 35 wt %, up to about 40 wt %, up to about 45 wt %, up to about 50 wt %, up to about 55 wt %, up to about 60 wt %, up to about 65 wt %, up to about 70 wt %, up to about 75 wt %, or more versus the total weight of the antimicrobial composite (e.g., the total weight of the dispersion medium and the matrix). In non-limiting embodiments, the antimicrobial composite comprises matrix in a weight percent of at least about 1 wt %, at least about 5 wt %, at least about 10 wt %, at least about 15 wt %, at least about 20 wt %, at least about 25 wt %, at least about 30 wt %, at least about 35 wt %, at least about 40 wt %, up to about 45 wt %, up to about 50 wt %, or more versus the total weight of the antimicrobial composite (e.g., the total weight of the dispersion medium and the matrix). In some embodiments, the antimicrobial composite comprises matrix in a weight percent of between about 1 wt % to about 80 wt %, between about 5 wt % to about 20 wt %, between about l0 wt % to about 20 wt %, between about l0 wt % to about 50 wt %, between about l0 wt % to about 60 wt %, between about 15 wt % to about 50 wt %, between about 15 wt % to about 60 wt %, between about 20 wt % to about 40 wt %, between about 20 wt % to about 50 wt %, between about 20 wt % to about 60 wt %, between about 25 wt % to about 40 wt %, between about 30 wt % to about 37 wt %, between about 30 wt % to about 40 wt %, between about 30 wt % to about 50 wt %, between about 30 wt % to about 60 wt %, between about 3 1 wt % to about 37 wt %, between about 32 wt % to about 37 wt %, between about 40 wt % to about 60 wt %, or between about 40 wt % to about 75 wt % versus the total weight of the antimicrobial composite (e.g., the total weight of the dispersion medium and the matrix). As a person skilled in the art will appreciate, when the antimicrobial composite comprises wood, pulp, paper, or paperboard, for example, the weight percent of delivery material (e.g. a silica-based delivery material) in the antimicrobial composite may be determined by conducting an ash test at 900° C.

In non-limiting embodiments, the antimicrobial composite comprises antimicrobial in a weight percent of at least about 0.001 wt %, at least about 0.01 wt %, at least about 0.05 wt %, at least about 0.1 wt %, at least about 0.5 wt %, at least about 1 wt %, at least about 1.5 wt %, at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, or more versus the total weight of the antimicrobial composite (e.g., the total weight of the dispersion medium and the matrix). In non-limiting embodiments, the antimicrobial composite comprises antimicrobial in a weight percent of up to about 0.001 wt %, up to about 0.005 wt %, up to about 0.01 wt %, up to about 0.05 wt %, up to about 0.1 wt %, up to about 0.5 wt %, up to about 1 wt %, up to about 2 wt %, up to about 5 wt %, up to about 7 wt %, up to about 8 wt %, up to about 9 wt %, up to about 10 wt % versus the total weight of the antimicrobial composite (e.g., the total weight of the dispersion medium and the matrix). In some embodiments, antimicrobial is present in the antimicrobial composite at between about between about 0.001 wt % and about 0.005 wt %, between about 0.001 wt % and about 0.01 wt %, between about 0.001 wt % and about 0.05 wt %, between about 0.001 wt % and about 0.1 wt %, between about 0.001 wt % and about 0.5 wt %, between about 0.001 wt % and about 1 wt %, between about 0.001 wt % and about 2 wt %, between about 0.001 wt % and about 5 wt %, between about 0.001 wt % and about 10 wt %, between about 0.01 wt % and about 0.05 wt %, %, between about 0.01 wt % and about 0.1 wt %, between about 0.01 wt % and about 0.15 wt %, between about 0.01 wt % and about 0.2 wt %, between about 0.01 wt % and about 0.5 wt %, between about 0.01 wt % and about 1 wt %, between about 0.01 wt % and about 1.5 wt %, between about 0.01 wt % and about 2 wt %, between about 0.01 wt % and about 5 wt %, between about 0.01 wt % and about 10 wt %, between about 0.05 wt % and about 0.1 wt %, between about 0.05 wt % and about 0.5 wt %, between about 0.05 wt % and about 1 wt %, between about 0.05 wt % and about 1.5 wt %, between about 0.05 wt % and about 2 wt %, between about 0.05 wt % and about 5 wt %, between about 0.05 wt % and about 10 wt %, between about 0.1 wt % and about 0.5 wt %, between about 0.1 wt % and about 1 wt %, between about 0.1 wt % and about 2 wt %, between about 0.1 wt % and about 5 wt %, between about 0.1 wt % and about 10 wt %, between about 0.5 wt % and about 1 wt %, between about 0.5 wt % and about 2 wt %, between about 0.5 wt % and about 5 wt %, between about 0.5 wt % and about 10 wt %, between about 1 wt % and about 5 wt %, between about 1 wt % and about 10 wt %, between about 1.5 wt % and about 10 wt %, between about 2 wt % and about 10 wt %, between about 4 wt % and about 10 wt %, between about 5 wt % and about 10 wt %, between about 7 wt % and about 10 wt %, between about 2 wt % and about 7 wt %, between about 2 wt % and about 10 wt %, or between about 4 wt % and about 10 wt %, versus the total weight of the antimicrobial composite (e.g., the total weight of the dispersion medium and the matrix). In the discussion above, the weight of the matrix is the total weight of the delivery material and antimicrobial. In an embodiment, the antimicrobial comprises clove oil or clove extract. In an embodiment, the antimicrobial comprises clove oil, vanilla extract, and lemongrass oil.

An example method for determining the weight percent of antimicrobial present in an antimicrobial composite is discussed below. It will be understood by those skilled in the art that, for tests relying on a solvent extracted sample of a representative active volatile or volatiles (e.g. a terpene, guaiacol derivative, primary phenylpropanoid, eugenyl acetate, or eugenol component of the antimicrobial), the representative active volatile sampled is used as a proxy to report and determine the weight percent of antimicrobial versus the antimicrobial composite. Unless specified otherwise below, the weight percent of antimicrobial in the antimicrobial composite is equivalent to the sum of the weight percents of the representative active volatiles (e.g. eugenol and eugenyl acetate) of the antimicrobial in the antimicrobial composite.

The weight percent of antimicrobial present in an antimicrobial composite is determined by measuring the concentration of representative active volatiles of the antimicrobial composite using a methanol extraction method. In a non-limiting embodiment, solvent application for purposes of performing methanol extraction in order to measure the weight percent of antimicrobial present versus the total weight of antimicrobial composite is performed as follows. A known mass of antimicrobial composite is placed in a vial (e.g., a 20 ml scintillation vial). A volume of 1.50 mL of methanol (for use in HPLC, >99.9%, Sigma Aldrich) is added to the vial. The vial is then sealed and placed on a shaker table for 60 min. An aliquot of 1.0 μL of the methanol solution sample of antimicrobial collected is then measured (e.g., using a gas chromatograph (GC)). The concentration (e.g., in mass per μL) of antimicrobial as calculated from the GC measurement is then multiplied by the volume of solvent used for extraction (1.50 mL, as stated above) to get the total mass of active in the antimicrobial composite. The mass of antimicrobial is then divided by the total mass of the antimicrobial composite previously placed in the vial to arrive at the weight percent of antimicrobial in the antimicrobial composite. If more than one representative active volatile is a component of the antimicrobial, the weight percent of antimicrobial present in the antimicrobial composite is equivalent to the sum of the weight percents of the representative active volatiles (e.g. eugenol and eugenyl acetate) of the antimicrobial in the antimicrobial composite.

The area of the GC peak may be calibrated by comparison against an internal standard. In each instance, the flame ionization detector (FID) response of the GC instrument is calibrated by the injection of variable quantities of a known standard of the pure analyte and using methods understood to those skilled in the art. In some embodiments, the pure analyte is the representative active volatile as discussed above.

As a non-limiting illustrative example, calculating the weight percent of an antimicrobial (e.g. clove oil) present in an antimicrobial composite, the methanol extraction method as described above is performed for each representative active volatiles (e.g. eugenol and eugenyl acetate). The weight percents of each representative active volatile (e.g. the weight percent of eugenol and the weight percent of eugenyl acetate) are added to achieve a proxy for the weight percent of antimicrobial present in an antimicrobial composite (e.g. clove oil). The sum of the calculated weight percents of the representative active volatiles may be reported as wt % antimicrobial present in the antimicrobial composite.

In an embodiment, determining the weight of the delivery material in an antimicrobial composite is used to estimate the total weight of the matrix in the antimicrobial composite. In an embodiment, determining the weight of the delivery material in an antimicrobial composite is used as a proxy to report the total weight of the matrix in the antimicrobial composite. In a non-limiting embodiment, determining the weight of the delivery material in an antimicrobial composite may be accomplished via a calcination protocol as follows. A sample of antimicrobial composite (e.g., a paper) of a known dimension (e.g., having an area of approximately one ft²) is weighed. That paper is placed into a glass jar container of known weight, which is then covered with a standard watchglass of known weight. The watchglass, jar, and paper material are then placed in a standard muffle, ash test, or calcination oven. The oven is then set to approximately 600° C. and allowed to reach temperature. Once 600° C. is reached, the oven is maintained at that temperature for not less than 3 hours. After the organic material of the antimicrobial composite has completely burned away, it is expected that only inorganic materials (e.g., the silica-based delivery material). The oven is turned off and allowed to return to room temperature, after which, the container, with its contents and watchglass are weighed. The weight of the container and watch glass are subtracted from the total weight to arrive at the inorganic-only weight to arrive at the weight of the delivery material in the antimicrobial composite.

In an embodiment, a packaging insert for use in, for example, pallets, boxes, cases, punnets, or clamshells (or other containers) for produce or animal products comprises an antimicrobial composite. For example, in some embodiments, a package comprises the packaging insert. The package comprising the packaging insert can be, for example, a container to which the packaging insert can be permanently or removably affixed. In an embodiment, the packaging insert comprises the antimicrobial composite and one or more of a water-absorbent material, an adhesive, a water-impermeable material, and a water-permeable material. In some embodiments, the packaging insert comprises one or more layers of antimicrobial composite, one or more water-absorbent layers, one or more adhesive layers, and one or more anti-fouling layers. In a non-limiting embodiment, the packaging insert is a pad. In a non-limiting embodiment, a pad comprises an antimicrobial composite and one or more of an adhesive, a water-absorbent layer, and a cushion. In an embodiment, the cushion comprises a pliable material which can be deformed so as to provide protection against mechanical damage of packaging contents, such as berries. In an embodiment, the cushion is also a water-absorbent material. In an embodiment, the cushion comprises a porous material. In an embodiment, the cushion is a porous material. In an embodiment, the cushion comprises a polyethylene film. In an embodiment, the cushion is a polyethylene film. In an embodiment a pad comprises a plurality of layers. In an embodiment, the pad comprises one or more layers comprising antimicrobial composite and one or more layers comprising polyethylene film. In an embodiment, at least one outer layer of the pad comprises polyethylene film. In an embodiment, the polyethylene film is food-safe. In an embodiment, at least one outer layer of the pad comprises an adhesive material. In a non-limiting embodiment, a pad may have dimensions of 3″×3″×¼″ or 10″×″20″×⅛″, for example. Layers of the pad may be assembled in any suitable order and may be affixed to each other using conventional techniques.

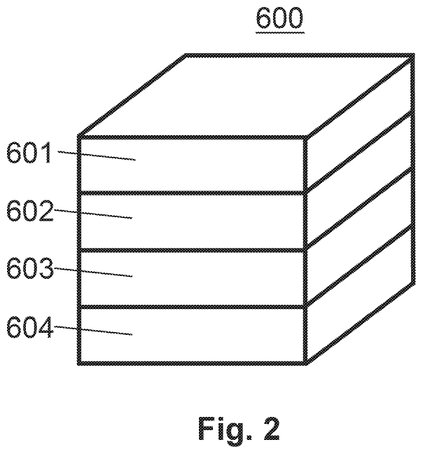

FIG. 2 illustrates a non-limiting example of a packaging insert 600 comprising four layers 601, 602, 603, and 604. Layers of the packaging insert may be assembled in any suitable order and may be affixed to each other using conventional techniques. In a non-limiting embodiment, at least one of layers 601, 602, 603, and 604 comprises a polymer. In a non-limiting embodiment, layer 601 comprises at least one of a polyethylene film, an anti-fouling layer (e.g. a material utilized for its inhospitability to dormant or active microbial life), a hygroscopic layer, a cushion, and a water absorbent layer. In a non-limiting embodiment, layer 601 comprises at least one of a polyethylene film, an anti-fouling material, a hygroscopic material or other water absorbent material, a porous material, and a cushion. In a non-limiting embodiment, layer 601 is one of an anti-fouling layer, a hygroscopic layer, a cushion, and, a water absorbent layer. In a non-limiting embodiment, the anti-fouling layer comprises a water-permeable plastic. In a non-limiting embodiment, layer 602 comprises an antimicrobial composite. In a non-limiting embodiment, the layers are physically separable and affixed using an adhesive, thermosealing, crimping, or some other physical means. In a non-limiting embodiment, layer 602 is an antimicrobial composite. In a non-limiting embodiment, layer 603 comprises a hygroscopic or other water absorbent material. In a non-limiting embodiment, layer 603 is a hygroscopic or other water absorbent material. In a non-limiting embodiment, layer 603 comprises at least one of a polyethylene film, an anti-fouling material, a hygroscopic material or other water absorbent material, a porous material, and a cushion. In a non-limiting embodiment, layer 604 comprises at least one of an adhesive material and an antimicrobial composite. In a non-limiting embodiment, layer 604 is one of an adhesive material and an antimicrobial composite. In some embodiments, the antimicrobial composite is wettable. In some embodiments, the antimicrobial composite is water-absorbent. In some embodiments, the antimicrobial composite is both wettable and water-absorbent. Although not shown, one skilled in the art will appreciate that the packaging insert may be permanently or removably affixed to one or more of a pallet, box, case, punnet, or clamshell for application to produce or animal products. In some embodiments, the adhesive layer is non-continuous. In some embodiments, the antimicrobial composite may be affixed to one or more of a pallet, box, case, punnet, or clamshell. In some embodiments, the antimicrobial composite may be affixed to one or more of a pallet, box, case, punnet, or clamshell via adhesive. In some embodiments, the adhesive is food-safe.

As used herein, “antimicrobial” means compounds which inhibit, kill, interfere with lifecycle processes including growth, maturation, and reproduction, or otherwise suppress the actions or adverse effects of pathogens, including viruses, bacteria, fungi, yeasts, vertebrate and invertebrate pests, irrespective of their specific nature or form. In some embodiments, the compositions as described herein relate to the release or controlled-release delivery of vapor-phase or gas-phase antimicrobials from a delivery material. A “vapor-phase antimicrobial” or “gas-phase antimicrobial” is an antimicrobial that is in the vapor-phase or gas phase, respectively, upon release from the delivery material at the desired conditions (e.g., ambient room temperature (about 21° C.-25° C.) and atmospheric pressure).

In some embodiments, an antimicrobial may extend the shelf life of an agricultural product, and improve the overall quality of the agricultural product, and/or may provide control over the product ripeness. Examples of antimicrobials include, but are not limited to: essential oils (e.g., natural or synthetic) and other compounds which may have antibacterial, antiviral, antifungal, or pesticidal applications for resistance to pathogens and pests in, for instance, post-harvest produce, animals, or humans; antioxidants for improving the shelf-life, odor, and color of, for instance, post-slaughter packaged meat products; antioxidants for improving color retention in, for instance, cut fruits, vegetables, and other agricultural products; antioxidants with potential health benefits for biological targets, for instance, pets and humans; perfumes, fragrances, improving the scent of or reducing the odor of, for instance, spaces, animals, or humans. Antimicrobials may include natural compositions, synthetic compositions, or a combination of both.

In an embodiment, the matrix is capable of releasing antimicrobial upon exposure to humidity. Without wishing to be limited by any particular theory or mechanism, water may competitively displace an antimicrobial (e.g. an essential oil) that has been previously adsorbed by the delivery material (e.g. silica). Upon exposure to the water vapor (e.g. originating from berries in proximity to or in contact with the matrix or antimicrobial composite), the antimicrobial adsorbed by the delivery material experiences competition from the humidity, such that the microscopic effect is the release of antimicrobial from the delivery material. In an embodiment the antimicrobial composite is configured for release of antimicrobial upon exposure to humidity.

In an embodiment, humidity activation effects release of antimicrobial from the matrix. In an embodiment, humidity activation effects release of antimicrobial from the matrix and from the antimicrobial composite. In an embodiment, the antimicrobial is in the vapor phase or gas phase upon release.

In an embodiment, in addition to humidity activation, direct contact of liquid water with the matrix can be used to drive release of the antimicrobial from the matrix and/or antimicrobial composite. In an embodiment, in addition to humidity activation, direct contact of solid water with the matrix can be used to drive release of the antimicrobial from the matrix and/or antimicrobial composite.

As noted elsewhere, certain embodiments are related to methods. In some embodiments, the method comprises exposing a composition comprising an antimicrobial stored in a delivery material (e.g., a silica-based delivery material) to humidity such that the antimicrobial is released from the composition. The delivery material can be, for example, any of the delivery materials described above or elsewhere herein.

The composition that is exposed to the humidity can be, in some embodiments, an antimicrobial composite, such as any of the antimicrobial composites described above or elsewhere herein.

Certain embodiments comprise exposing a package comprising produce and a composition, the composition comprising an antimicrobial, to humidity such that the antimicrobial is released from the composition.

In certain embodiments, the humidity to which the composition is exposed is emitted by the produce. For example, produce may emit humidity, and the emitted humidity may subsequently interact with a composition (e.g., an antimicrobial composite, a packaging insert, etc.) such that antimicrobial is released from the composition.

In some embodiments, the release of the antimicrobial reduces microbial and/or fungal activity of the produce. The released antimicrobial may, for example, suppress the actions or adverse effects of pathogens or pests (e.g., pathogens or pests associated with produce).

In some embodiments, the method comprises, in addition to exposing the composition to humidity, exposing the composition to liquid water and/or solid water.

### Humidity Response Characteristics—Matrix

In some embodiments, humidity response characteristics of a matrix can be assessed by measuring release characteristics from the matrix at different relative humidities at the same temperature. In some embodiments, a matrix which releases antimicrobial when exposed to water vapor could be characterized by being hygroscopic, that is, spontaneously adsorbing water from ambient humidities (such as water vapor originating from produce during respiration or condensation), for example. In some embodiments, a matrix which releases antimicrobial when exposed to water vapor could be characterized as having a significant accessible chemical surface area (for example, greater than 100 m²/g). In some embodiments, the release characteristics of antimicrobial from a matrix can be assessed by measuring the rate of release of antimicrobial from the matrix over time. In some embodiments wherein release characteristics of an antimicrobial from a matrix are reported as an amount of antimicrobial (e.g., a volume, mass, or molar quantity) released per gram of matrix (i.e. the matrix being the delivery material and antimicrobial) per unit time, the rate of release is reported on a per hour basis. In some embodiments, release rate of antimicrobial from a matrix is calculated via headspace analysis (during a release test as discussed below) of a representative active volatile component of antimicrobial in the matrix. In some embodiments, the representative active volatile for headspace analysis is a volatile component of one or more antimicrobial oils or antimicrobial extracts of the matrix that is a vapor-phase or gas-phase compound upon release from the matrix i) resolvable via gas chromatography (GC) analysis (e.g., the peak can be separated from other GC peaks and the volatile has a commercially available standard), and ii) known to exhibit antimicrobial activity. In some embodiments, the representative active volatile is the largest contributor to signal when under headspace gas chromatographic analysis. In some embodiments, the representative active volatile is a terpene. In some embodiments, the representative active volatile is a guaiacol derivative. In some embodiments, the representative active volatile is a phenylpropanoid. In some embodiments, the representative active volatile is a eugenol. In some embodiments, the representative active volatile is eugenyl acetate. In a non-limiting embodiment, when a matrix comprises clove oil or clove extract, release rate of antimicrobial from the matrix is calculated via headspace analysis (during a release test as discussed below) of eugenol. In a non-limiting embodiment, when a matrix comprises clove oil or clove extract, release rate of antimicrobial from the matrix is calculated via headspace analysis (during a release test as discussed below) of eugenyl acetate. It will be understood by those skilled in the art that, for a pure compound measured via headspace analysis (e.g., eugenol or eugenyl acetate), molar and mass quantities are interconvertible, and that either may be converted to volume for a gas, provided temperature, pressure, and the molecular weight of the gas are known, as determined using the ideal gas law.

An example method for determining release rate of antimicrobial from a matrix is discussed below. It will be understood by those skilled in the art that, for release tests relying on headspace sampling of a representative active volatile, terpene, guaiacol derivative, primary phenylpropanoid, eugenyl acetate, or eugenol, the compound sampled is used as a proxy to report and determine the rate of release of antimicrobial per gram of matrix per hour. Unless specified otherwise below, the rate of release of antimicrobial per gram of matrix per hour is equivalent to the rate of release of the selected representative active volatile of the antimicrobial per gram of matrix per hour.

The rate of release of antimicrobial per gram of matrix per hour is determined by measuring an average amount of antimicrobial released from the matrix between two particular timepoints (e.g., hour 1 and, subsequently, hour 24) following humidity application (e.g. matrix exposure to humidity). In a non-limiting embodiment, humidity application for purposes of administering a release test occurs as follows. A known mass of matrix is placed in a small vial (e.g., a 2-dram vial), the small vial then nested in a larger vial (e.g., 10 mL amber vial). A solution corresponding to the desired relative humidity (e.g., 75% relative humidity) is loaded into the larger vial (e.g., into the bottom of the larger vial via pipette) so that the matrix is kept from direct water contact. The larger vial is then closed (e.g., by attaching a screw-top cap equipped with Teflon septa). In some embodiments, “hour zero” is defined as the instant the vial cap is closed after the solution is loaded into the larger vial. In some embodiments, the vial cap is closed immediately after the solution is loaded into the larger vial. In some embodiments, the instant of humidity application is the instant the cap is closed after the solution is loaded into the larger vial. For the performance of a release test, one of ordinary skill in the art will appreciate that known methods may be used for humidity application to the matrix while keeping the matrix away from direct contact with water. For example, saturated salt solutions of LiCl, MgCl, or NaCl can be prepared in H₂O and loaded into the larger vial via pipette to create the desired humidity environment for the release test.

In some embodiments release rate from the matrix is reported as an amount of antimicrobial (e.g., in moles) released per gram of matrix (e.g., the matrix being the delivery material and antimicrobial) per unit time. In some embodiments, assessing the average release rate over a particular range of hours (e.g., hours 1 to 24) is calculated based on the difference of moles of antimicrobial sampled from the headspace between the two timepoints.

A non-limiting example of how to measure the release rate of antimicrobial from a matrix for hour 1 is as follows. Prior to commencement of the release test, the mass of the matrix (e.g., the matrix being a delivery material charged with antimicrobial) to be studied is measured or known (e.g., in grams). As would be appreciated by one of ordinary skill of the art, the total mass of the matrix measured prior to commencement of the release test is the total mass of the matrix measured prior to humidity application; this is also known as the total mass of matrix initially measured or known. The release study commences at hour zero, immediately after humidity application, as discussed above. In an embodiment, the vial is permitted to equilibrate for the sixty (60) minutes (i.e. until hour 1) following hour zero. The antimicrobial released from the matrix over the sixty (60) minutes after hour zero is collected (e.g., in the sealed nested vials as discussed above) and sampled (e.g., using conventional headspace methodologies) at hour 1. The sample of antimicrobial collected is then measured (e.g., using a gas chromatograph (GC)). The amount (e.g., in moles or mass) of antimicrobial released as calculated from the GC measurement is then divided by the total mass of the matrix (e.g., in grams) as initially measured or known, as discussed above. The resulting numerical figure is the amount (e.g., in moles or mass) of antimicrobial released per gram matrix per hour for hour 1.

A non-limiting example of how to measure the average release rate of antimicrobial from the same matrix (e.g., during the same release test) from hour 1 to hour 24 is as follows. The antimicrobial released from the matrix one (1) hour after the vial is sealed is collected (e.g., in the sealed nested vials as discussed above) and sampled (e.g., using conventional gas chromatography headspace methodologies) at hour 1. The vial is left to age for another 23 hours. The antimicrobial released from the matrix over the total twenty-four (24) hours after the vial is sealed (at hour 0, as discussed above) is collected (e.g., in the sealed nested vials as discussed above) and sampled (e.g., using conventional gas chromatography headspace methodologies) at hour 24. The amount (e.g., in moles or mass) of antimicrobial released as calculated from the GC measurement at the previous hour measured (e.g., hour 1) is subtracted from the amount (e.g., in moles or mass, respectively) of antimicrobial released as calculated from the GC measurement at hour 24. The resulting amount of antimicrobial released (e.g., in moles or mass, respectively) is then divided by the total mass of the matrix (e.g., in grams) as initially measured or known, as discussed above. The resulting numerical figure is then divided by the elapsed time between the previous hour measured (e.g., hour 1) and the current hour (in this case hour 24), which is 23 hours, to obtain the release rate of antimicrobial (amount of antimicrobial/g matrix/hour) from the matrix. In an embodiment, that resulting numerical figure is the release rate reported for hour 24.

A non-limiting example of how to measure the average release rate of antimicrobial from the same matrix (e.g., during the same release test) from hour 24 to hour 48 is as follows. The antimicrobial released from the matrix over the total twenty-four (24) hours after the vial is sealed is collected, as discussed above. The vial is left to age for another 24 hours. The antimicrobial released from the matrix over the total twenty-four (24) hours after the sampling at hour 24 is collected and sampled (e.g., using conventional gas chromatography headspace methodologies) at hour 48. The amount (e.g., in moles or mass) of antimicrobial released as calculated from the GC measurement at the previous hour measured (e.g., hour 24) is subtracted from the amount (e.g., in moles or mass, respectively) of antimicrobial released as calculated from the GC measurement at hour 48. The resulting amount of antimicrobial released (e.g., in moles or mass, respectively) is then divided by the total mass of the matrix (e.g., in grams) as initially measured or known, as discussed above. The resulting numerical figure is then divided by the elapsed time between the previous hour measured (e.g., hour 24) and the current hour (in this case hour 48), which is 24 hours, to obtain the release rate of antimicrobial (amount of antimicrobial/g matrix/hour) from the matrix. In an embodiment, that resulting numerical figure is the release rate reported for hour 48.

Those with ordinary skill in the art will be aware of conventional headspace methodologies that use, for example, gas chromatography (GC). A non-limiting example of a method that uses headspace analysis to measure release rate of antimicrobial is provided as follows. The matrix comprising antimicrobial, is placed in nested vials for humidity application (as discussed above). The rate of release may be calibrated based on the number of hours that antimicrobial is permitted to build up in the vial headspace while the larger vial is sealed. Depending on the length of time antimicrobial is permitted to build-up while the vial is sealed, the rate of release at a given time point can be calculated by sampling the headspace of the vial and injecting a sample volume (e.g., 100 μL to 300 μL) in a GC in accordance with methods known to those of ordinary skill in the art. The area of the GC peak may be calibrated by comparison against an internal standard. In each instance, the flame ionization detector (FID) response of the GC instrument is calibrated by the injection of variable quantities of a known standard of the pure analyte and using methods understood to those skilled in the art. In some embodiments, the pure analyte is the representative active volatile as discussed above.

For example, for calculating the release of eugenol (for example, as a proxy for assessing the release of clove oil) from a matrix, the area of the GC peak may be calibrated against known quantities of eugenol. Eugenol is obtainable as a 99% pure liquid (for example, from Sigma Aldrich chemical company). In a non-limiting embodiment, the release of an essential oil antimicrobial may be calculated based on headspace sampling of its representative active volatile during a release test with humidity application as discussed above.

The matrices described herein are humidity activated. In some embodiments, humidity activation is measured by performing release tests (as discussed above) with different humidity applications (e.g., 15% relative humidity, 33% relative humidity, 75% relative humidity, or 99% relative humidity) on matrices having substantially the same initial mass and composition. For each different relative humidity application release test (e.g., at 15% relative humidity, 33% relative humidity, 75% relative humidity, or 99% relative humidity on a matrix having substantially the same initial mass and composition) used to measure humidity activation of the matrix, it is important to sample the vial headspace at the same timepoints after hour zero for all release tests. This is because humidity activation is calculated by normalizing the antimicrobial release rate (calculated as discussed above) for each sample timepoint against the antimicrobial release rate at that timepoint from a 99% relative humidity application. For example, in order to calculate humidity activation for a matrix having release of antimicrobial from a matrix at hour 24, release tests as indicated above are performed on a matrix (having the same or substantially the same initial mass and composition) at 15% relative humidity application, 33% relative humidity application, 75% relative humidity application, or 99% relative humidity application. Headspace samples are taken at the same timepoints after hour zero for each release test administered (for example, at hour 1, hour 5, hour 24, and hour 48). Then humidity activation for a particular timepoint (e.g., hour 24) is calculated by normalizing all release rates for each relative humidity application at that timepoint (e.g., hour 24) to the release rate determined for the 99% relative humidity application. Table 1 below provides a non-limiting example of the calculated humidity activation for hour 24 at 21° C. using eugenol release (as discussed above) as a proxy for antimicrobial release from a matrix comprising a silica-based delivery material and clove oil.

TABLE 1
Example of Humidity Activation Calculation for Hour 24
from a Matrix

| | | Release Rate |
|---|---|---|
| | | (mol/g |
| % Relative Humidity | Humidity Activation | matrix/hr) |
| 99 | 1.000 | 1.141E−10 |
| 75 | 0.564 | 6.432E−11 |
| 33 | 0.032 | 3.639E−12 |
| 15 | 0.002 | 1.790E−13 |

Table 2 below provides a non-limiting example of the calculated humidity activation for hour 24 at 21° C. using eugenyl acetate release (as discussed above) as a proxy for antimicrobial release from a matrix comprising a silica-based delivery material and clove oil. As would be understood by one skilled in the art, “E” is used herein to indicate scientific notation and is equivalent to “multiplied by ten to the power of”. As an illustrative example, “2.0E-2” would be equivalent to 2.0×10⁻². As would be understood by one of skill in the art, attempts to measure concentrations of materials, regardless of analytical technique, can result in nominally negative values as the concentration of antimicrobial approaches the detection limit of the technique. Because a negative concentration does not have physical meaning in this context, negative nominal values indicate that the value of the concentration is lower than the technique detection limit. Therefore, such values may also be indicted as “0” or “nil”.

TABLE 2
Example of Humidity Activation Calculation for Hour 24
from a Matrix

| | | Release Rate |
|---|---|---|
| | | (mol/g |
| % Relative Humidity | Humidity Activation | matrix/hr) |
| 99 | 1.000 | 3.289E−13 |
| 75 | 1.201 | 3.949E−13 |
| 33 | 0.034 | 1.121E−14 |
| 15 | nil | nil |

As discussed above, antimicrobial release may be quantified as a release rate, which may be reported as an amount of antimicrobial (as reported as moles of the matrix's component representative active volatile, for example) released per gram of matrix per hour (moles/g matrix/hr). The humidity response characteristics set forth below for the matrices described herein are, unless otherwise stated, given for release tests conducted as described above at specified relative humidity at 21° C. and determined for hour 24 as discussed above. In a non-limiting embodiment, the humidity response characteristics set forth below relate to release rates from a matrix calculated via headspace analysis of a representative active volatile. In a non-limiting embodiment, the humidity response characteristics set forth below relate to release rates from a matrix calculated via headspace analysis of eugenol. In a non-limiting embodiment, the humidity response characteristics set forth below relate to release rates from a matrix calculated via headspace analysis of eugenyl acetate. It should be understood that throughout the duration of the release tests, temperature and atmospheric pressure around the matrix material is kept substantially constant. In some embodiments, the matrix is considered humidity activated if the release rate at 15% relative humidity is less than about 1% of the release rate at 99% relative humidity. In some embodiments, the matrix is considered humidity activated if the release rate at 15% relative humidity is less than about 5% of the release rate at 99% relative humidity. In some embodiments, the matrix is considered humidity activated if the release rate at 15% relative humidity is less than about 10% of the release rate at 99% relative humidity. In some embodiments, the matrix is considered humidity activated if the release rate at 15% relative humidity is less than about 20% of the release rate at 99% relative humidity. In some embodiments, the matrix is considered humidity activated if the release rate at 15% relative humidity is less than about 30% of the release rate at 99% relative humidity. In some embodiments, the matrix is considered humidity activated if the release rate at 15% relative humidity is between about 0.0001% and about 0.2% of the release rate at 99% relative humidity. In some embodiments, the matrix is considered humidity activated if the release rate at 15% relative humidity is between about 0.0001% and about 0.5% of the release rate at 99% relative humidity. In some embodiments, the matrix is considered humidity activated if the release rate at 15% relative humidity is between about 0.0001% and about 1% of the release rate at 99% relative humidity. In some embodiments, the matrix is considered humidity activated if the release rate at 15% relative humidity is between about 0.0001% and about 5% of the release rate at 99% relative humidity. In some embodiments, the matrix is considered humidity activated if the release rate at 15% relative humidity is between about 0.0001% and about 10% of the release rate at 99% relative humidity. In some embodiments, the matrix is considered humidity activated if the release rate at 33% relative humidity is less than about 1% of the release rate at 99% relative humidity. In some embodiments, the matrix is considered humidity activated if the release rate at 33% relative humidity is less than about 5% of the release rate at 99% relative humidity. In some embodiments, the matrix is considered humidity activated if the release rate at 33% relative humidity is less than about 10% of the release rate at 99% relative humidity. In some embodiments, the matrix is considered humidity activated if the release rate at 33% relative humidity is less than about 20% of the release rate at 99% relative humidity. In some embodiments, the matrix is considered humidity activated if the release rate at 33% relative humidity is less than about 30% of the release rate at 99% relative humidity. In some embodiments, the matrix is considered humidity activated if the release rate at 33% relative humidity is between about 0.0001% and about 0.2% of the release rate at 99% relative humidity. In some embodiments, the matrix is considered humidity activated if the release rate at 33% relative humidity is between about 0.0001% and about 0.5% of the release rate at 99% relative humidity. In some embodiments, the matrix is considered humidity activated if the release rate at 33% relative humidity is between about 0.0001% and about 1% of the release rate at 99% relative humidity. In some embodiments, the matrix is considered humidity activated if the release rate at 33% relative humidity is between about 0.0001% and about 5% of the release rate at 99% relative humidity. In some embodiments, the matrix is considered humidity activated if the release rate at 33% relative humidity is between about 0.0001% and about 10% of the release rate at 99% relative humidity. In some embodiments, the matrix is considered humidity activated if the release rate at 33% relative humidity is between about 0.0001% and about 20% of the release rate at 99% relative humidity. In some embodiments, the matrix is considered humidity activated if the release rate at 33% relative humidity is between about 0.0001% and about 30% of the release rate at 99% relative humidity. In some embodiments, the matrix is considered humidity activated if the release rate at 50% relative humidity is greater than about 30% of the release rate at 99% relative humidity. In some embodiments, the matrix is considered humidity activated if the release rate at 75% relative humidity is greater than about 30% of the release rate at 99% relative humidity. In some embodiments, the matrix is considered humidity activated if the release rate at 75% relative humidity is greater than about 40% of the release rate at 99% relative humidity. In some embodiments, the matrix is considered humidity activated if the release rate at 75% relative humidity is greater than about 50% of the release rate at 99% relative humidity. In some embodiments, the matrix is considered humidity activated if the release rate at 75% relative humidity is greater than about 60% of the release rate at 99% relative humidity. In some embodiments, the matrix is considered humidity activated if the release rate at 75% relative humidity is greater than about 70% of the release rate at 99% relative humidity. In some embodiments, the matrix is considered humidity activated if the release rate at 75% relative humidity is greater than about 80% of the release rate at 99% relative humidity. In some embodiments, the matrix is considered humidity activated if the release rate at 75% relative humidity is greater than about 90% of the release rate at 99% relative humidity. In some embodiments, the matrix is considered humidity activated if the release rate at 75% relative humidity is greater than about 95% of the release rate at 99% relative humidity. In some embodiments, the matrix is considered humidity activated if the release rate at 75% relative humidity is greater than about 99% of the release rate at 99% relative humidity. In some embodiments, the matrix is considered humidity activated if the release rate at 75% relative humidity is between about 30% and about 99% of the release rate at 99% relative humidity. In some embodiments, the matrix is considered humidity activated if the release rate at 75% relative humidity is between about 40% and about 99% of the release rate at 99% relative humidity. In some embodiments, the matrix is considered humidity activated if the release rate at 75% relative humidity is between about 50% and about 99% of the release rate at 99% relative humidity. In some embodiments, the matrix is considered humidity activated if the release rate at 75% relative humidity is between about 60% and about 99% of the release rate at 99% relative humidity. In some embodiments, the matrix is considered humidity activated if the release rate at 75% relative humidity is between about 70% and about 99% of the release rate at 99% relative humidity. In some embodiments, the matrix is considered humidity activated if the release rate at 75% relative humidity is between about 80% and about 99% of the release rate at 99% relative humidity. In some embodiments, the matrix is considered humidity activated if the release rate at 75% relative humidity is between about 85% and about 99% of the release rate at 99% relative humidity. In some embodiments, the matrix is considered humidity activated if the release rate at 75% relative humidity is between about 90% and about 99% of the release rate at 99% relative humidity. In some embodiments, the matrix is considered humidity activated if the release rate at 75% relative humidity is between about 30% and about 95% of the release rate at 99% relative humidity. In some embodiments, the matrix is considered humidity activated if the release rate at 75% relative humidity is between about 40% and about 95% of the release rate at 99% relative humidity. In some embodiments, the matrix is considered humidity activated if the release rate at 75% relative humidity is between about 50% and about 95% of the release rate at 99% relative humidity. In some embodiments, the matrix is considered humidity activated if the release rate at 75% relative humidity is between about 60% and about 95% of the release rate at 99% relative humidity. In some embodiments, the matrix is considered humidity activated if the release rate at 75% relative humidity is between about 70% and about 95% of the release rate at 99% relative humidity. In some embodiments, the matrix is considered humidity activated if the release rate at 75% relative humidity is between about 80% and about 95% of the release rate at 99% relative humidity. In some embodiments, the matrix is considered humidity activated if the release rate at 75% relative humidity is between about 85% and about 95% of the release rate at 99% relative humidity. In some embodiments, the matrix is considered humidity activated if the release rate at 75% relative humidity is between about 90% and about 95% of the release rate at 99% relative humidity. In a non-limiting embodiment, the humidity response characteristics above relate to the release of at least one of an antimicrobial, a terpene, a guaiacol derivative, a phenylpropanoid, eugenol, and eugenyl acetate from a matrix. In a non-limiting embodiment, the humidity response characteristics above relate to the release of at least clove oil and clove extract from a matrix.

### Humidity Response Characteristics—Antimicrobial Composite

In some embodiments, humidity response characteristics of an antimicrobial composite can be assessed by measuring release characteristics from the antimicrobial composite at different relative humidities at the same temperature. In some embodiments, the release characteristics of antimicrobial from an antimicrobial composite can be assessed by measuring the rate of release of antimicrobial from the antimicrobial composite over time. In some embodiments wherein release characteristics of an antimicrobial from an antimicrobial composite are reported as an amount of antimicrobial (e.g., a volume, mass, or molar quantity) released per gram of matrix (i.e. the matrix being the delivery material and antimicrobial) per unit time, the rate of release is reported on a per hour basis. In some embodiments, release rate of antimicrobial from an antimicrobial composite is calculated via headspace analysis (during a release test as discussed below) of a representative active volatile component of antimicrobial in the matrix. In some embodiments, the representative active volatile for headspace analysis is a volatile component of one or more antimicrobial oils or antimicrobial extracts of the matrix incorporated into the antimicrobial composite that is a vapor-phase or gas-phase compound upon release from the matrix i) resolvable via gas chromatography (GC) analysis (e.g., the peak can be separated from other GC peaks and the volatile has a commercially available standard), and ii) known to exhibit antimicrobial activity. In some embodiments, the representative active volatile is the largest contributor to signal when under headspace gas chromatographic analysis. In some embodiments, the representative active volatile is a terpene. In some embodiments, the representative active volatile is a guaiacol derivative. In some embodiments, the representative active volatile is a phenylpropanoid. In some embodiments, the representative active volatile is eugenol. In some embodiments, the representative active volatile is eugenyl acetate. In a non-limiting embodiment, when a matrix comprises clove oil or clove extract, release rate of antimicrobial from the matrix is calculated via headspace analysis (during a release test as discussed below) of eugenol. In a non-limiting embodiment, when a matrix comprises clove oil or clove extract, release rate of antimicrobial from the matrix is calculated via headspace analysis (during a release test as discussed below) of eugenyl acetate. It will be understood by those skilled in the art that, for a pure compound measured via headspace analysis (e.g., eugenol or eugenyl acetate), molar and mass quantities are interconvertible, and that either may be converted to volume for a gas, provided temperature, pressure, and the molecular weight of the gas are known, as determined using the ideal gas law.

An example method for determining release rate of antimicrobial from an antimicrobial composite is discussed below. It will be understood by those skilled in the art that, for release tests relying on headspace sampling of a representative active volatile, terpene, guaiacol derivative, primary phenylpropanoid, eugenyl acetate, or eugenol, the compound sampled is used as a proxy to report and determine the rate of release of antimicrobial per gram of matrix per hour. Unless specified otherwise below, the rate of release of antimicrobial per gram of matrix per hour is equivalent to the rate of release of the selected representative active volatile of the antimicrobial per gram of matrix per hour.

The rate of release of antimicrobial per gram of matrix per hour from an antimicrobial composite is determined by measuring an average amount of antimicrobial released from the antimicrobial composite between two particular timepoints (e.g., hour 1 and, subsequently, hour 24) following humidity application. In a non-limiting embodiment, humidity application for purposes of administering a release test occurs as follows. A known mass of antimicrobial composite is placed in a small vial (e.g., a 2-dram vial), the small vial then nested in a larger vial (e.g., 10 mL amber vial). A solution corresponding to the desired relative humidity (e.g., 75% relative humidity) is loaded into the larger vial (e.g., into the bottom of the larger vial via pipette) so that the matrix is kept from direct water contact. The larger vial is then closed (e.g., by attaching a screw-top cap equipped with Teflon septa). In some embodiments, “hour zero” is defined as the instant the vial cap is closed after the solution is loaded into the larger vial. In some embodiments, the vial cap is closed immediately after the solution is loaded into the larger vial. In some embodiments, the instant of humidity application is the instant the cap is closed after the solution is loaded into the larger vial. For the performance of a release test, one of ordinary skill in the art will appreciate that known methods may be used for humidity application to the matrix while keeping the matrix away from direct contact with water. For example, saturated salt solutions of LiCl, MgCl, or NaCl can be prepared in H₂O and loaded into the larger vial via pipette to create the desired humidity environment for the release test.

In some embodiments release rate from the antimicrobial composite is reported as an amount of antimicrobial (e.g., in moles) released per gram of matrix (e.g., the matrix being the delivery material and antimicrobial) per unit time. In some embodiments, assessing the average release rate over a particular range of hours (e.g., hours 1 to 24) is calculated based on the difference of moles of antimicrobial sampled from the headspace between the two timepoints.

A non-limiting example of how to measure the release rate of antimicrobial from a matrix for hour 1 is as follows. Prior to commencement of the release test, the mass of the antimicrobial composite to be studied is measured or known (e.g., in grams). As would be appreciated by one of ordinary skill of the art, the total mass of the antimicrobial composite measured prior to commencement of the release test is the total mass of the antimicrobial composite measured prior to humidity application; this is also known as the total mass of antimicrobial composite initially measured or known. The release study commences at hour zero, immediately after humidity application, as discussed above. In an embodiment, the vial is permitted to equilibrate for the sixty (60) minutes (i.e. until hour 1) following hour zero. The antimicrobial released from the antimicrobial composite over the sixty (60) minutes after hour zero is collected (e.g., in the sealed nested vials as discussed above) and sampled (e.g., using conventional headspace methodologies) at hour 1. The sample of antimicrobial collected is then measured (e.g., using a gas chromatograph (GC)). The amount (e.g., in moles or mass) of antimicrobial released as calculated from the GC measurement is then divided by the total mass of the matrix in the antimicrobial composite. As discussed above, a calcination protocol can be used to determine the mass of matrix in the antimicrobial composite. The resulting numerical figure is the amount (e.g., in moles or mass) of antimicrobial released per gram matrix per hour for hour 1 (for the antimicrobial composite).

A non-limiting example of how to measure the average release rate of antimicrobial from the same antimicrobial composite (e.g., during the same release test) from hour 1 to hour 24 is as follows. The antimicrobial released from the antimicrobial composite one (1) hour after the vial is sealed is collected (e.g., in the sealed nested vials as discussed above) and sampled (e.g., using conventional gas chromatography headspace methodologies) at hour 1. The vial is left to age for another 23 hours. The antimicrobial released from the antimicrobial composite over the total twenty-four (24) hours after the vial is sealed (at hour 0, as discussed above) is collected (e.g., in the sealed nested vials as discussed above) and sampled (e.g., using conventional gas chromatography headspace methodologies) at hour 24. The amount (e.g., in moles or mass) of antimicrobial released as calculated from the GC measurement at the previous hour measured (e.g., hour 1) is subtracted from the amount (e.g., in moles or mass, respectively) of antimicrobial released as calculated from the GC measurement at hour 24. The resulting amount of antimicrobial released (e.g., in moles or mass, respectively) is then divided by the total mass of the matrix (e.g., in grams, either known or determined via calcination for example) in the antimicrobial composite sampled, as discussed above. The resulting numerical figure is then divided by the elapsed time between the previous hour measured (e.g., hour 1) and the current hour (in this case hour 24), which is 23 hours, to obtain the release rate of antimicrobial (amount of antimicrobial/g matrix/hour) from the matrix (for the antimicrobial composite). In an embodiment, that resulting numerical figure is the release rate reported for hour 24.

A non-limiting example of how to measure the average release rate of antimicrobial from the same antimicrobial composite (e.g., during the same release test) from hour 24 to hour 48 is as follows. The antimicrobial released from the antimicrobial composite over the total twenty-four (24) hours after the vial is sealed is collected, as discussed above. The vial is left to age for another 24 hours. The antimicrobial released from the matrix over the total twenty-four (24) hours after the sampling at hour 24 is collected and sampled (e.g., using conventional gas chromatography headspace methodologies) at hour 48. The amount (e.g., in moles or mass) of antimicrobial released as calculated from the GC measurement at the previous hour measured (e.g., hour 24) is subtracted from the amount (e.g., in moles or mass, respectively) of antimicrobial released as calculated from the GC measurement at hour 48. The resulting amount of antimicrobial released (e.g., in moles or mass, respectively) is then divided by the total mass of the matrix (e.g., in grams, either known or determined via calcination, for example) in the antimicrobial composite sampled, as discussed above. The resulting numerical figure is then divided by the elapsed time between the previous hour measured (e.g., hour 24) and the current hour (in this case hour 48), which is 24 hours, to obtain the release rate of antimicrobial (amount of antimicrobial/g matrix/hour) from the matrix (for the antimicrobial composite). In an embodiment, that resulting numerical figure is the release rate reported for hour 48.

Those with ordinary skill in the art will be aware of conventional headspace methodologies that use, for example, gas chromatography (GC). A non-limiting example of a method that uses headspace analysis to measure release rate of antimicrobial is provided as follows. The antimicrobial composite comprising antimicrobial, is placed in nested vials for humidity application (as discussed above). The rate of release may be calibrated based on the number of hours that antimicrobial is permitted to build up in the vial headspace while the larger vial is sealed. Depending on the length of time antimicrobial is permitted to build-up while the vial is sealed, the rate of release at a given time point can be calculated by sampling the headspace of the vial and injecting a sample volume (e.g., 100 μL to 300 μL) in a GC in accordance with methods known to those of ordinary skill in the art. The area of the GC peak may be calibrated by comparison against an internal standard. In each instance, the flame ionization detector (FID) response of the GC instrument is calibrated by the injection of variable quantities of a known standard of the pure analyte and using methods understood to those skilled in the art. In some embodiments, the pure analyte is the representative active volatile as discussed above.

For example, for calculating the release of eugenol (for example, as a proxy for assessing the release of clove oil) from a matrix, the area of the GC peak may be calibrated against known quantities of eugenol. Eugenol is obtainable as a 99% pure liquid (for example, from Sigma Aldrich chemical company). In a non-limiting embodiment, the release of an essential oil antimicrobial may be calculated based on headspace sampling of its representative active volatile during a release test with humidity application as discussed above.

The antimicrobial composites described herein are humidity activated. In some embodiments, humidity activation is measured by performing release tests (as discussed above) with different humidity applications (e.g., 15% relative humidity, 33% relative humidity, 75% relative humidity, or 99% relative humidity) on matrices having substantially the same initial mass and composition. For each different relative humidity application release test (e.g., at 15% relative humidity, 33% relative humidity, 75% relative humidity, or 99% relative humidity on a matrix having substantially the same initial mass and composition) used to measure humidity activation of the matrix, it is important to sample the vial headspace at the same timepoints after hour zero for all release tests. This is because humidity activation is calculated by normalizing the antimicrobial release rate (calculated as discussed above) for each sample timepoint against the antimicrobial release rate at that timepoint from a 99% relative humidity application. For example, in order to calculate humidity activation for a matrix having release of antimicrobial from a matrix at hour 24, release tests as indicated above are performed on a matrix (having the same or substantially the same initial mass and composition) at 15% relative humidity application, 33% relative humidity application, 75% relative humidity application, or 99% relative humidity application. Headspace samples are taken at the same timepoints after hour zero for each release test administered (for example, at hour 1, hour 5, hour 24, and hour 48). Then humidity activation for a particular timepoint (e.g., hour 24) is calculated by normalizing all release rates for each relative humidity application at that timepoint (e.g., hour 24) to the release rate determined for the 99% relative humidity application. Table 1 below provides a non-limiting example of the calculated humidity activation for hour 24 at 21° C. using eugenyl acetate release (as discussed above) as a proxy for antimicrobial release from an antimicrobial composite comprising a silica-based delivery material and clove oil. As discussed above, as would be understood by one of skill in the art, attempts to measure concentrations of materials, regardless of analytical technique, can result in nominally negative values as the concentration of antimicrobial approaches the detection limit of the technique. Because a negative concentration does not have physical meaning in this context, negative nominal values indicate that the value of the concentration is lower than the technique detection limit. Therefore, such values may also be indicted as “0” or “nil”.

TABLE 3
Example of Humidity Activation Calculation for Hour 24
from an Antimicrobial Composite

| | | Release Rate |
|---|---|---|
| | | (mol/g |
| % Relative Humidity | Humidity Activation | matrix/hr) |
| 99 | 1.000 | 2.576E−13 |
| 75 | 0.914 | 2.355E−13 |
| 33 | nil | nil |
| 15 | nil | nil |

As discussed above, antimicrobial release for an antimicrobial composite may be quantified as a release rate, which may be reported as an amount of antimicrobial (as reported as moles of the matrix's component representative active volatile, for example) released per gram of matrix per hour (moles/g matrix/hr). The humidity response characteristics set forth below for the antimicrobial composites described herein are, unless otherwise stated, given for release tests conducted as described above at specified relative humidity at 21° C. and determined for hour 24 as discussed above. In a non-limiting embodiment, the humidity response characteristics set forth below relate to release rates from an antimicrobial composite calculated via headspace analysis of a representative active volatile. In a non-limiting embodiment, the humidity response characteristics set forth below relate to release rates from an antimicrobial composite calculated via headspace analysis of eugenol. In a non-limiting embodiment, the humidity response characteristics set forth below relate to release rates from an antimicrobial composite calculated via headspace analysis of eugenyl acetate. It should be understood that throughout the duration of the release tests, temperature and atmospheric pressure around the antimicrobial composite is kept substantially constant. In some embodiments, the antimicrobial composite is considered humidity activated if the release rate at 15% relative humidity is less than about 1% of the release rate at 99% relative humidity. In some embodiments, the antimicrobial composite is considered humidity activated if the release rate at 15% relative humidity is less than about 5% of the release rate at 99% relative humidity. In some embodiments, the antimicrobial composite is considered humidity activated if the release rate at 15% relative humidity is less than about 10% of the release rate at 99% relative humidity. In some embodiments, the antimicrobial composite is considered humidity activated if the release rate at 15% relative humidity is less than about 20% of the release rate at 99% relative humidity. In some embodiments, the antimicrobial composite is considered humidity activated if the release rate at 15% relative humidity is less than about 30% of the release rate at 99% relative humidity. In some embodiments, the antimicrobial composite is considered humidity activated if the release rate at 15% relative humidity is between about 0.0001% and about 0.2% of the release rate at 99% relative humidity. In some embodiments, the antimicrobial composite is considered humidity activated if the release rate at 15% relative humidity is between about 0.0001% and about 0.5% of the release rate at 99% relative humidity. In some embodiments, the antimicrobial composite is considered humidity activated if the release rate at 15% relative humidity is between about 0.0001% and about 1% of the release rate at 99% relative humidity. In some embodiments, the antimicrobial composite is considered humidity activated if the release rate at 15% relative humidity is between about 0.0001% and about 5% of the release rate at 99% relative humidity. In some embodiments, the antimicrobial composite is considered humidity activated if the release rate at 15% relative humidity is between about 0.0001% and about 10% of the release rate at 99% relative humidity. In some embodiments, the antimicrobial composite is considered humidity activated if the release rate at 33% relative humidity is less than about 1% of the release rate at 99% relative humidity. In some embodiments, the antimicrobial composite is considered humidity activated if the release rate at 33% relative humidity is less than about 5% of the release rate at 99% relative humidity. In some embodiments, the antimicrobial composite is considered humidity activated if the release rate at 33% relative humidity is less than about 10% of the release rate at 99% relative humidity. In some embodiments, the antimicrobial composite is considered humidity activated if the release rate at 33% relative humidity is less than about 20% of the release rate at 99% relative humidity. In some embodiments, the antimicrobial composite is considered humidity activated if the release rate at 33% relative humidity is less than about 30% of the release rate at 99% relative humidity. In some embodiments, the antimicrobial composite is considered humidity activated if the release rate at 33% relative humidity is between about 0.0001% and about 0.2% of the release rate at 99% relative humidity. In some embodiments, the antimicrobial composite is considered humidity activated if the release rate at 33% relative humidity is between about 0.0001% and about 0.5% of the release rate at 99% relative humidity. In some embodiments, the antimicrobial composite is considered humidity activated if the release rate at 33% relative humidity is between about 0.0001% and about 1% of the release rate at 99% relative humidity. In some embodiments, the antimicrobial composite is considered humidity activated if the release rate at 33% relative humidity is between about 0.0001% and about 5% of the release rate at 99% relative humidity. In some embodiments, the antimicrobial composite is considered humidity activated if the release rate at 33% relative humidity is between about 0.0001% and about 10% of the release rate at 99% relative humidity. In some embodiments, the antimicrobial composite is considered humidity activated if the release rate at 33% relative humidity is between about 0.0001% and about 20% of the release rate at 99% relative humidity. In some embodiments, the antimicrobial composite is considered humidity activated if the release rate at 33% relative humidity is between about 0.0001% and about 30% of the release rate at 99% relative humidity. In some embodiments, the antimicrobial composite is considered humidity activated if the release rate at 50% relative humidity is greater than about 30% of the release rate at 99% relative humidity. In some embodiments, the antimicrobial composite is considered humidity activated if the release rate at 75% relative humidity is greater than about 30% of the release rate at 99% relative humidity. In some embodiments, the antimicrobial composite is considered humidity activated if the release rate at 75% relative humidity is greater than about 40% of the release rate at 99% relative humidity. In some embodiments, the antimicrobial composite is considered humidity activated if the release rate at 75% relative humidity is greater than about 50% of the release rate at 99% relative humidity. In some embodiments, the antimicrobial composite is considered humidity activated if the release rate at 75% relative humidity is greater than about 60% of the release rate at 99% relative humidity. In some embodiments, the antimicrobial composite is considered humidity activated if the release rate at 75% relative humidity is greater than about 70% of the release rate at 99% relative humidity. In some embodiments, the antimicrobial composite is considered humidity activated if the release rate at 75% relative humidity is greater than about 80% of the release rate at 99% relative humidity. In some embodiments, the antimicrobial composite is considered humidity activated if the release rate at 75% relative humidity is greater than about 90% of the release rate at 99% relative humidity. In some embodiments, the antimicrobial composite is considered humidity activated if the release rate at 75% relative humidity is greater than about 95% of the release rate at 99% relative humidity. In some embodiments, the antimicrobial composite is considered humidity activated if the release rate at 75% relative humidity is greater than about 99% of the release rate at 99% relative humidity. In some embodiments, the antimicrobial composite is considered humidity activated if the release rate at 75% relative humidity is between about 30% and about 99% of the release rate at 99% relative humidity. In some embodiments, the antimicrobial composite is considered humidity activated if the release rate at 75% relative humidity is between about 40% and about 99% of the release rate at 99% relative humidity.

In some embodiments, the antimicrobial composite is considered humidity activated if the release rate at 75% relative humidity is between about 50% and about 99% of the release rate at 99% relative humidity. In some embodiments, the antimicrobial composite is considered humidity activated if the release rate at 75% relative humidity is between about 60% and about 99% of the release rate at 99% relative humidity. In some embodiments, the antimicrobial composite is considered humidity activated if the release rate at 75% relative humidity is between about 70% and about 99% of the release rate at 99% relative humidity. In some embodiments, the antimicrobial composite is considered humidity activated if the release rate at 75% relative humidity is between about 80% and about 99% of the release rate at 99% relative humidity. In some embodiments, the antimicrobial composite is considered humidity activated if the release rate at 75% relative humidity is between about 85% and about 99% of the release rate at 99% relative humidity. In some embodiments, the antimicrobial composite is considered humidity activated if the release rate at 75% relative humidity is between about 90% and about 99% of the release rate at 99% relative humidity. In some embodiments, the antimicrobial composite is considered humidity activated if the release rate at 75% relative humidity is between about 30% and about 95% of the release rate at 99% relative humidity. In some embodiments, the antimicrobial composite is considered humidity activated if the release rate at 75% relative humidity is between about 40% and about 95% of the release rate at 99% relative humidity. In some embodiments, the antimicrobial composite is considered humidity activated if the release rate at 75% relative humidity is between about 50% and about 95% of the release rate at 99% relative humidity. In some embodiments, the antimicrobial composite is considered humidity activated if the release rate at 75% relative humidity is between about 60% and about 95% of the release rate at 99% relative humidity. In some embodiments, the antimicrobial composite is considered humidity activated if the release rate at 75% relative humidity is between about 70% and about 95% of the release rate at 99% relative humidity. In some embodiments, the antimicrobial composite is considered humidity activated if the release rate at 75% relative humidity is between about 80% and about 95% of the release rate at 99% relative humidity. In some embodiments, the antimicrobial composite is considered humidity activated if the release rate at 75% relative humidity is between about 85% and about 95% of the release rate at 99% relative humidity. In some embodiments, the antimicrobial composite is considered humidity activated if the release rate at 75% relative humidity is between about 90% and about 95% of the release rate at 99% relative humidity. In a non-limiting embodiment, the humidity response characteristics above relate to the release of at least one of an antimicrobial, a terpene, a guaiacol derivative, a phenylpropanoid, eugenol, and eugenyl acetate from an antimicrobial composite. In a non-limiting embodiment, the humidity response characteristics above relate to the release of at least clove oil and clove extract from an antimicrobial composite.

In some embodiments, one or more antimicrobials may stored in and released from the delivery materials discussed herein. For example, when an antimicrobial is stored in a delivery material, it can be associated (e.g., via adsorption) with the interior surfaces of the delivery material (e.g., pore surfaces), the exterior of the delivery material (e.g., the exterior surface of a particle), or both. In a non-limiting embodiment, the use of compositions described herein can be used to improve the quality and shelf life of produce. For example, the quality, shelf-life, or value of produce may be maintained by the inhibition of the growth, homeostasis, reproduction, nutrition, or other essential life processes of pathogens and pests such as yeasts, fungi, bacteria, and animal pests. In an embodiment, the antimicrobial is a compound or multiple compounds with efficacy in applications as an antiviral, antifungal, antimicrobial, antibacterial, antipathogen, biocide, pesticide, preservative, or biopesticide agent or agent(s). The antimicrobial may slow or inhibit the growth or sprouting of one or more viruses, fungi, microbes, bacteria, pathogens, pests, or insects. The antimicrobial may reduce the latent pathogen content as measured by, for example, spore or endospore count of agricultural produce (a.k.a. produce) by slowing or inhibiting the growth of one or more viruses, fungi, microbes, bacteria, pathogens, pests, or insects. The antimicrobial may reduce the physical, physiological, biological, or cosmetic symptoms caused by the action of one or more viruses, fungi, microbes, bacteria, pathogens, pests, or insects. The antimicrobial may extend the shelf life of agricultural produce by slowing or inhibiting the growth of, or optionally reducing the physical, physiological, biological, or cosmetic symptoms caused by, the action of one or more viruses, fungi, microbes, bacteria, pathogens, pests, or insects on the produce. The products and processes described herein may be applied to either pre-harvest or post-harvest produce.

“Produce” as used herein and above means agricultural and horticultural products, including pre- and post-harvest unprocessed and processed agricultural and horticultural products. Examples of produce include, but are not limited to fruits, vegetables, flowers, ornamental plants, herbs, grains, seeds, fungi (e.g., mushrooms) and nuts. Processed produce refers to produce that has been altered by at least one mechanical, chemical, or physical process that modify the natural state or appearance of the produce. Mashed, cut, peeled, diced, squeezed, and chopped produce are non-limiting examples of processed produce. Produce also can refer to hydroponically-grown plants.

In a non-limiting embodiment, produce comprises berries. A composition comprising a delivery material and at least one antimicrobial may be used, for example, to extend the shelf life of berries, including but not limited to strawberries, raspberries, blueberries, blackberries, elderberries, gooseberries, golden berries, grapes, champagne grapes, Concord grapes, red grapes, black grapes, green grapes, and globe grapes. In an embodiment, antimicrobial in the vapor phase extends the shelf life of berries by optionally slowing or inhibiting the growth of, or optionally reducing the physical, physiological, biological, or cosmetic symptoms caused by, the action of one or more viruses, fungi, microbes, bacteria, pathogens, pests, or insects on the berries.

In a non-limiting embodiment, produce comprises vegetables. Examples of vegetables that may be treated by the compositions described herein include, but are not limited to, leafy green vegetables such as lettuce (e.g., Lactuea sativa), spinach (Spinaca oleracea) and cabbage (Brassica oleracea); various roots, tap roots, tubers, stem roots, and bulbs such as potatoes (Solanum tuberosum), sweet potato, yam, taro, ginseng, cassava, dahlia, onions (Allium sp.), shallot, turnip (brassica rapa), ginger (Zingiber officinale), and carrots (Daucus); herbs such as basil (Ocimum basilicum), oregano (Origanum vulgare) and dill (Anethum graveolens); as well as soybean (Glycine max), lima beans (Phaseolus limensis), snapbeans (Phaseolus vulgaris), peas (Lathyrus sp.), corn (Zea mays), broccoli (Brassica oleracea italica), cauliflower (Brassica oleracea botrytis) and asparagus (Asparagus officinalis).

In a non-limiting embodiment, produce comprises fruit. Examples of fruits that may be treated by the compositions described herein include, but are not limited to tomatoes (Lycopersicon esculentum), apples (Malus domestica), bananas (Musa sapientum), cherries (Prunus avium), grapes (Vitis vinifera), pears (Pyrus communis), papaya (Carica papya), mangoes (Mangifera indica), peaches (Prunus persica), apricots (Prunus armeniaca), nectarines (Prunus persica nectarina), oranges (Citrus sp.), lemons (Citrus limonia), limes (Citrus aurantifolia), grapefruit (Citrus paradisi), tangerines (Citrus nobilis deliciosa), kiwi (Actinidia chinenus), melons such as cantaloupes (C. cantalupensis) and musk melons (C. melo), honeydew, pineapples (Aranae comosus), persimmon (Diospyros sp.) and raspberries (e.g., Fragaria or Rubus ursinus), blueberries (Vaccinium sp.), green beans (Phaseolus vulgaris), members of the genus Cucumis such as cucumber (C. sativus), starfruit, and avocados (Persea americana).

In a non-limiting embodiment, produce comprises fungi consumed as food or in medicine, for example. Examples of fungi that may be treated by the compositions described herein include, but are not limited to, wood ear, shitake, oyster mushroom (and other members of the genus Pleurotus), enokitake, members of the genus Lactarius, morels, truffles (genus Tuber), Agaricus bisporus, straw mushroom, Chanterelles, and Blewit.

In a non-limiting embodiment, produce comprises cut flowers or ornamental plants. Examples of ornamental plants that may be treated by the compositions described herein include, but are not limited to, potted ornamentals and cut flowers. Potted ornamentals and cut flowers which may be treated with the methods of the present invention include azalea (Rhododendron spp.), hydrangea (Macrophylla hydrangea), hibiscus (Hibiscus rosasanensis), snapdragons (Antirrhinum sp.), poinsettia (Euphorbia pulcherima), cactus (e.g., Cactaceae schlumbergera truncata), begonias (Begonia sp.), roses (Rosa sp.), tulips (Tulipa sp.), daffodils (Narcissus sp.), petunias (Petunia hybrida), carnation (Dianthus caryophyllus), lily (e.g., Lilium sp.), gladiolus (Gladiolus sp.), Alstroemeria (Alstroemaria brasiliensis), anemone (e.g., Anemone bland), columbine (Aquilegia sp.), aralia (e.g., Aralia chinesis), aster (e.g., Aster carolinianus), bougainvillea (Bougainvillea sp.), camellia (Camellia sp.), bellflower (Campanula sp.), cockscomb (Celosia sp.), falsecypress (Chamaecyparis sp.), chrysanthemum (Chrysanthemum sp.), clematis (Clematis sp.), cyclamen (Cyclamen sp.), freesia (e.g., Freesia refracta), and orchids of the family Orchidaceae.

In a non-limiting embodiment, produce comprises plants. Examples of plants that may be treated by the compositions described herein include, but are not limited to, cannabis (as a whole plant or portion of a plant) cotton (Gossypium spp.), pecans (Carva illinoensis), coffee (Cofffea arabica), weeping fig (Ficus benjamina), and tropical fruits, as well as dormant seedlings such as various fruit trees including apple, ornamental plants, shrubbery, and tree seedlings. In addition, shrubbery which may be treated with the compositions described herein include, but are not limited to, privet (Ligustrum sp.), photinea (Photina sp.), holly (Ilex sp.), ferns of the family Polypodiaceae, schefflera (Schefflera sp.), aglaonema (Aglaonema sp.), cotoneaster (Cotoneaster sp.), barberry (Berberris sp.), waxmyrtle (Myrica sp.), abelia (Abelia sp.), acacia (Acacia sp.), and bromeliades of the family Bromeliaceae.

In an embodiment, the antimicrobial has anti-bacterial, anti-fungal, anti-algae, anti-viral, mold inhibitors, or other preventative or curative properties such as having insecticidal and insect repellent properties. In an embodiment, the preservatives may include natural or synthetic compositions with anti-oxidant properties. These preservatives may be suitable for applications such as the packaging and preservation of perishable substances such as produce, meat products, dairy products, edible substances, non-edible substances, and other perishable substances.

In a non-limiting embodiment, an antimicrobial comprises an essential oil. In a non-limiting embodiment, an antimicrobial is an essential oil. In some embodiments, essential oils have detectable concentrations of terpenes and/or terpenoids that provide antibacterial and/or antifungal properties. In a non-limiting embodiment, an antimicrobial is a terpene or a terpenoid. Non-limiting examples of terpenes include acyclic and cyclic terpenes, monoterpenes, diterpenes, oligoterpenes, and polyterpenes with any degree of substitution. In a non-limiting embodiment, an antimicrobial is an essential oil comprising an extract from, for example, an herb, a plant, a trees, or a shrub. In a non-limiting embodiment, an essential oil comprises at least one of a terpene, a terpenoid, a phenol, or a phenolic compounds. Non-limiting examples of essential oils and essential oil extracts include, thymol, curcumin, carvacrol, bay leaf oil, lemongrass oil, clove oil, peppermint oil, spearmint oil, oil of winter green, acacia oil, eucalyptol, limonene, eugenol, menthol, farnesol, carvone, hexanal, thyme oil, dill oil, oregano oil, neem oil, orange peel oil, lemon peel oil, rosemary oil, or cumin seed extract. In a non-limiting embodiment, an antimicrobial is at least one of oregano oil, thyme oil, hexanal, carvacrol, thymol, methyl salicylate, eugenol, and eugenyl acetate. In a non-limiting embodiment, a matrix comprises one or more terpenes and/or terpenoids or other botanical actives. For example, in some embodiments, the matrix comprises antimicrobial selected from the group consisting of clove oil, lemongrass oil, vanilla oil, vanilla extract, eugenol, eugenyl acetate, citronellal, and vanillin, curcumin, carvacrol, methyl jasmonate and derivatives, carvone, hexanal, thyme oil, dill oil, oregano oil, neem oil, orange peel oil, lemon peel oil, cumin seed extract and combinations thereof. A person skilled in the art will appreciate other essential oils and/or terpenes and terpenoids that may be incorporated into the matrices described herein.

In some embodiments, the delivery material is a solid having a high surface area, as described in more detail herein. In some embodiments, the delivery material is porous. In some embodiments, the delivery material is nanoporous. Non-limiting examples of porous materials are macroporous, mesoporous, and microporous materials. In some embodiments, the porous and/or nanoporous delivery material comprises one or more of macropores, mesopores, and micropores. In a non-limiting embodiment, macropores are pores having a diameter greater than 50 nm. For example, macropores may have diameters of between 50 and 1000 nm. In a non-limiting embodiment, mesopores are pores having a diameter between 2 nm and 50 nm. In a non-limiting embodiment, micropores are pores having a diameter of less than 2 nm. For example, micropores may have diameters of between 0.2 and 2 nm.

In an embodiment, a delivery material may include, but is not limited to, nanoporous, macroporous, microporous, or mesoporous silicates, or organosilicate hybrids. In a non-limiting embodiment, the delivery material has an elemental composition indistinguishable from that of sand. In an embodiment, the delivery material comprises silica particles with the chemical formula SiO₂. In a non-limiting embodiment, the delivery material comprising silica particles with the chemical formula SiO₂ stores and/or releases antimicrobial.

In a non-limiting embodiment, the matrix comprises a delivery material, being a silica-based material, and at least one antimicrobial. The delivery material may be used to store and/or release the antimicrobial. In some embodiments, the antimicrobial may be in the vapor-phase or gas-phase upon release from the matrix. In some embodiments, clove oil is released from the matrix in the vapor-phase or gas-phase. In some embodiments, clove extract is released from the matrix in the vapor-phase or gas-phase. In some embodiments, eugenol is released from the matrix in the vapor-phase or gas-phase. In some embodiments, eugenyl acetate is released from the matrix in the vapor-phase or gas-phase. In some embodiments, a matrix comprising clove oil or clove extract releases eugenol upon humidity activation. In some embodiments, a matrix comprising clove oil or clove extract releases eugenyl acetate upon humidity activation.

In a non-limiting embodiment, the delivery material is a silicate material, also referred to herein as a silica-based delivery material. Silica-based delivery materials generally include silicon atoms and oxygen atoms at least some of which are bound to silicon atoms. The silicon atoms and the oxygen atoms may be present in the silica-based delivery material, for example, in the form of oxidized silicon. Silica-based delivery materials can include, for example, materials that are or comprise silicon dioxide, other forms of silicates, and combinations thereof. Silica-based delivery materials may include, in addition to the silicon and oxygen atoms, other materials such as metal oxides (e.g., aluminum oxide (Al₂O₃)). In some embodiments, the amount of silicon atoms, by weight, in the silica-based delivery material is at least about 1 wt %, at least about 3 wt %, at least about 5 wt %, at least about 10 wt %, or at least about 20 wt %. In some embodiments, the amount of oxygen atoms, by weight, in the silica-based delivery material is at least about 1 wt %, at least about 3 wt %, at least about 5 wt %, at least about 10 wt %, or at least about 20 wt %. In certain embodiments, the total amount of the silicon atoms and the oxygen atoms within the silica-based delivery material is at least about 1 wt %, at least about 3 wt %, at least about 5 wt %, at least about 10 wt %, at least about 20 wt %, at least about 25 wt %, at least about 30 wt %, at least about 40 wt %, at least about 50 wt %, at least about 60 wt %, at least about 70 wt %, at least about 80 wt %, at least about 90 wt %, at least about 95 wt %, or at least about 99 wt %.

In a non-limiting embodiment, the delivery material (e.g., the silica-based delivery material) is or comprises a silicate. Silicates may include neosilicates, sorosilicates, cyclosilicates, inosilicates, phyllosilicates, and/or tectosilicates. In some embodiments, at least about 1 wt %, at least about 3 wt %, at least about 5 wt %, at least about 10 wt %, at least about 20 wt %, at least about 25 wt %, at least about 30 wt %, at least about 40 wt %, at least about 50 wt %, at least about 60 wt %, at least about 70 wt %, at least about 80 wt %, at least about 90 wt %, at least about 95 wt %, or at least about 99 wt % of the delivery material is made of silicate.

In some embodiments, at least about 1 wt %, at least about 3 wt %, at least about 5 wt %, at least about 10 wt %, at least about 20 wt %, at least about 25 wt %, at least about 30 wt %, at least about 40 wt %, at least about 50 wt %, at least about 60 wt %, at least about 70 wt %, at least about 80 wt %, at least about 90 wt %, at least about 95 wt %, or at least about 99 wt % of the delivery material is made of silicon dioxide.

A silica-based delivery material may be of various geometries and formations including, but not limited to, macroporous, mesoporous, and microporous silica-based materials, amorphous silica, fumed silica, particulate silica of all sizes, ground quartz, particulate, fumed, crystalline, precipitated, and ground silicon dioxide and associated derivatives, and combinations thereof. In some embodiments, a silica based delivery material comprises silica gel, or precipitated, crystalline-free silica gel (such as generally indicated by CAS No.: 112926-00-8), or amorphous, fumed (crystalline free) silica (such as generally indicated by CAS No.: 112945-52-5), or mesostructured amorphous silica (such as generally indicated by CAS No.: 7631-86-9). In some embodiments, silica-based delivery material further comprises one or more of a metal oxide, metalloid oxide, and combinations thereof. For example, in some embodiments, the silica-based delivery material further comprises one or more of zinc oxide, titanium oxide, group 13 or 14 oxide, and combinations thereof. In some embodiments, silica-based delivery material further comprises aluminum oxide or a portion of aluminum oxide.

In some embodiments, a delivery material comprising a silica-based material comprises silica. Silicate materials are available from commercial sources in a wide array of states with respect to surface areas, porosities, degrees of surface functionalization, acidity, basicity, metal contents, and other chemical and physicochemical features. Commercial silicates may be in the form of powder, granules, nanoscale particles, and porous particles. In some embodiments, the delivery material comprises silica gel. In some embodiments, the silica-based delivery material comprises silica gel. In some embodiments, the delivery material comprises one or more of macropores, mesopores, and micropores. In some embodiments, the silica-based delivery material comprises one or more of macroporous, mesoporous, and microporous silica. In some embodiments the delivery material comprises precipitated, crystalline-free silica gel (such as generally indicated by CAS No.: 112926-00-8). In some embodiments, the delivery material comprises amorphous, fumed (crystalline free) silica (such as generally indicated by CAS No. 112945-52-5). In some embodiments, the delivery material comprises mesostructured amorphous silica (such as generally indicated by CAS No. 7631-86-9). In a non-limiting embodiment, a silica-based delivery material comprises one or more of a polysiloxane, polyalkylsiloxane, and polyalkylenesiloxane materials; a polyoxoalkyelene material, metal oxide, and a zeolite.

In a non-limiting embodiment, a delivery material comprises optionally an adsorption-modifying functionality. An adsorption-modifying functionality is any chemical functionality that modifies the interaction between an antimicrobial and a delivery material, such that the introduction of the chemical functionality (a) increases or decreases the storage capacity of a delivery material (with respect to the storage capacity of the delivery material absent that chemical functionality) for antimicrobial, or (b) accelerates or decelerates the release of antimicrobial from a delivery material (with respect to the release of antimicrobial from the delivery material absent that chemical functionality). Such modifiable interactions include, but are not limited to, covalent binding, dative binding, electrostatic binding, van der Waals binding, or chelative binding of an appropriate antimicrobial. A non-limiting example of an adsorption-modifying functionality is one or more hydrophobic groups, for instance trimethylsilyl-functionalities, incorporated in a delivery material via grafting. While the compositions here are not limited to any particular theory or mechanism, it is contemplated that adsorption-modifying functionalities comprising hydrophobic or aliphatic groups in the pore space of the delivery material promote van der Waals interactions with hydrophobic antimicrobials to help stabilize the hydrophobic antimicrobials. In a non-limiting embodiment, a delivery material comprises more than one type of adsorption-modifying functionality.

A non-limiting example of a silica-based delivery material and method of manufacture are provided below:

A silica-based delivery material comprising adsorption-modifying functionalities can be prepared in the following manner, the adsorption-modifying functionalities being trimethylsilyl functionalities. A silica gel material with an average pore diameter of 60 Å and a particle size distribution of 37-74μ circle equivalent diameter (CED) (Sigma-Aldrich, Davisil Grade 633, high purity) can be purchased. A quantity, 10 g, of this material is suspended in 250 mL of anhydrous toluene in a flask under an inert atmosphere. To this mixture is added 10 mL of trimethylchlorosilane, which may be purchased from Alfa-Aesar. The reaction mixture is refluxed for 18 hours to graft the trimethylsilyl functionalities to the silica. The reaction mixture is then cooled and the solid recovered by filtration, washed with hexanes, and dried in an oven at 100° C. This procedure therefore results in a material with similar pore size and surface area to the parent silica gel, but with aliphatically modified walls, that, for example, modifies the chemical potential of the matrix with hydrophobic antimicrobials as compared to what would be the chemical potential of hydrophobic antimicrobials with the unmodified parent material.

In a non-limiting embodiment, the delivery materials are solid materials. In a non-limiting embodiment porous delivery materials are also high surface area materials. Without wishing to be limited by any particular theory or mechanism, porous, high surface area materials are beneficial in this application due to their adsorption capacity and sufficient affinity arising from that adsorption capacity to exhibit volatile (e.g. antimicrobial) retention greater than the evaporation retention of a neat liquid. In a non-limiting embodiment, a high-surface area material is a material with a total chemical surface area, internal and external, of at least about 1 m²/g. In some embodiments, a high-surface area material is a material with a total chemical surface area, internal and external, of at least about 10 m²/g. In some embodiments, a high-surface area material is a material with a total chemical surface area, internal and external, of at least about 50 m²/g. In some embodiments, a high-surface area material is a material with a total chemical surface area, internal and external, of at least about 90 m²/g. In some embodiments, a high-surface area material is a material with a total chemical surface area, internal and external, greater than about 400 m²/g. In some embodiments, a high-surface area material is a material with a total chemical surface area, internal and external, of at least about 500 m²/g. In some embodiments, a high-surface area material is a material with a total chemical surface area, internal and external, greater than about 1000 m²/g. In some embodiments, a high-surface area material is a material with a total chemical surface area, internal and external, greater than about 2000 m²/g. The terms “total chemical surface area, internal and external”, “chemical surface area” and “surface area” are used interchangeably herein. Those of ordinary skill in the will be aware of methods for determining the total chemical surface area, internal and external, for example, using Brunauer-Emmett-Teller (BET) analysis of nitrogen or noble gas desorption when a material (e.g., a porous material) is exposed to vacuum at a given temperature, for instance as by the ISO 9277 standard.

In a non-limiting embodiment, a silica-based delivery material has a surface area in the range of about 50 to about 1500 m²/g. In a non-limiting embodiment, a silica-based delivery material has a surface area in the range of about 100 to about 1500 m²/g. In a non-limiting embodiment, a silica-based delivery material has a surface area in the range of about 250 to about 1000 m²/g. In a non-limiting embodiment, a silica-based delivery material has a surface area in the range of about 300 to about 1200 m²/g. In a non-limiting embodiment, a silica-based delivery material has a surface area in the range of about 350 to about 850 m²/g. In a non-limiting embodiment, a silica-based delivery material has a surface area in the range of about 400 to about 800 m²/g. In a non-limiting embodiment, a silica-based delivery material has a surface area in the range of about 400 to about 600 m²/g. In a non-limiting embodiment, a silica-based delivery material has a surface area in the range of about 450 to about 650 m²/g. In a non-limiting embodiment, a silica-based delivery material has a surface area in the range of about 600 to about 800 m²/g. In a non-limiting embodiment, a silica-based delivery material has a surface area in the range of about 620 to about 820 m²/g.

In a non-limiting embodiment, a silica-based delivery material has an average pore diameter (for example, as measured by the method of Barrett, Joyner, and Halenda in ASTM Standard Test Method D4641-17), between about 5 Å to about 100 Å, between about 20 Å to about 100 Å, between about 30 Å to about 90 Å, between about 40 Å to about 100 Å, between about 40 Å to about 80 Å, between about 40 Å to about 70 Å, between about 40 Å to about 75 Å, between about 40 Å to about 65 Å, between about 50 Å to about 75 Å, between about 50 Å to about 65 Å, between about 55 Å to about 65 Å, or between about 57 Å to about 63 Å. Without wishing to being limited to any particular theory or mode of operation, it is believed that, in general, larger pores relative to the size of the antimicrobial molecule reduce the humidity-driven release aspect of the product (i.e., they will be less humidity-sensitive) and smaller pores result in higher humidity sensitivity, given a fixed pore volume. It is further believed that this trend will discontinue when the pores are sufficiently small that molecules of the antimicrobial cannot enter the pores in a sufficiently facile manner.

In a non-limiting embodiment, a silica-based delivery material is a material with an internal void volume between about 0.1 mL/g to about 1.5 mL/g, between about 0.3 mL/g to about 1.3 mL/g, between about 0.5 mL/g to about 1.5 mL/g, between about 0.5 mL/g to about 1.3 mL/g, between about 0.5 mL/g to about 1.0 mL/g, between about 0.5 mL/g to about 0.9 mL/g, between about 0.6 mL/g to about 1.0 mL/g, between about 0.6 mL/g to about 0.9 mL/g, between about 0.6 mL/g to about 0.8 mL/g, between about 0.7 mL/g to about 1.0 mL/g, between about 0.8 mL/g to about 1.0 mL/g, between about 0.8 mL/g to about 1.5 mL/g, between about 0.9 mL/g to about 1.5 mL/g, or between about 0.9 mL/g to about 1.3 mL/g. The terms “internal void volume” and “pore volume” may be used interchangeably. Pore volume or internal void volume is defined as the fraction of bulk volume of a solid not occupied by solid material. In the case of a silica-based delivery material, pore volume or internal void volume can be measured by infusing the bulk silica-based material with a fluid and then measuring the difference in volume (in the case of a liquid) or pressure (in the case of a gas) between the presence and absence of the solid. One skilled in the art will understand that mercury porosimetry may be used for this purpose.

Preparation, loading, or charging of the delivery material with antimicrobial to produce a matrix can be performed by, for example and including, but not limited to, directly contacting the delivery material with the pure liquid antimicrobial; directly contacting the delivery material with a solution of any kind containing antimicrobial; directly contacting the delivery material with antimicrobial in pure gas form; directly contacting the delivery material with a gas mixture containing antimicrobial; directly contacting the delivery material with antimicrobial in the vapor phase; directly contacting the delivery material with a gas mixture containing antimicrobial in the vapor phase.

The matrix can be utilized as a free material, as in a powder contained within a packet, pouch, sachet, or pad. Alternatively, the matrices may be incorporated into a structure, such as a dispersion medium, which may be a polymeric structure, for example, non-wovens, wovens, knits, coated substrates, impregnated substrates, papers, cardboard, paper products, paper derivatives, fabrics, cellulose, wood fiber, other fibers, films, cloths, and coatings to form an antimicrobial composite. In some embodiments, the matrices may be incorporated into a structure through compression molding, extrusion, injection molding, blow molding, dry spinning, melt spinning, wet spinning, solution casting, spray drying, solution spinning, film blowing, calendaring, rotational molding, powder injection molding, thixomolding, and other various methods. Incorporation of the matrices into a structure may enhance the applicability or processability of the material, and/or reduce the cost, labor, or time necessary to deploy antimicrobial, to a food commodity, for example, in a commercially effective manner.

In a non-limiting embodiment, the matrix is incorporated into a structure or form factor by being sealed inside the structure or form factor. In a non-limiting embodiment, the structure or form factor is comprised of a material that is one or more of food safe, non-absorptive, air permeable (but not necessarily porous). In a non-limiting embodiment, the one or more of food safe, non-absorptive, air permeable (but not necessarily porous) structure comprises a sachet. In a non-limiting embodiment, the sachet is porous. In an embodiment, the delivery material is charged with antimicrobial prior to being deposited and sealed in a sachet. For example, the sachet may be prepared by depositing the matrix in the sachet and then sealing the sachet.

In a non-limiting embodiment, a sachet material comprises one of a polypropylene material, polyethylene material (e.g., TYVEK™), and a cellulose based material. In a non-limiting embodiment, the Gurley Hill porosity measurement of a sachet material is 45-60 sec/100 cm²-in.

Structures, including antimicrobial composites, may comprise certain particle size distribution of a matrix dispersed or incorporated within it. Without wishing to be limited by any particular theory or mechanism, for a fixed mass of delivery material, certain particle sizes may be beneficial as change in particle size also changes the total amount of surface area of the delivery material available for antimicrobial adsorption and subsequent humidity displacement, for example. Additionally, smaller average particle sizes (e.g. below 60 μm) of matrix material as a component of an antimicrobial composite are beneficial as they provide less grainy-ness to the antimicrobial composite and as such are more attractive commercially. For example, without wishing to be limited by any particular theory or mechanism, it is anticipated that the bound capacity of the matrix will increase with decreasing particle size for a fixed mass of material. In a non-limiting embodiment, an antimicrobial composite comprises matrix having an average particle size (as determined in circle equivalent diameter (CED)) of between about 5 μm and about 250 μm, between about 10 μm and about 150 μm, between about 10 μm and about 40 μm, between about 10 μm and about 50 μm, between about 20 μm and about 40 μm, between about 25 μm and about 45 μm, between about 20 μm and about 50 μm, between about 20 μm and about 60 μm, between about 30 μm and about 150 μm, between about 50 μm and about 150 μm, between about 60 μm and about 120 μm, between about 40 μm and about 65 μm, between about 35 μm and about 75 μm, between about 52 μm and about 75 μm, between about 20 μm and about 80 μm, between about 20 between about 30 μm and about 80 μm, or between about 10 μm and about 80 μm. As used herein, circle equivalent diameter (CED) is equivalent to spherical equivalent diameter, which means the diameter of a spherical object that would result in the equivalent measurement observed for a polydisperse particle, irregular particle, or particle otherwise subject to uncertainty in their three-dimensional shape. As a skilled artisan will appreciate, CED is measured by conventional sieving techniques.

In some embodiments, an antimicrobial composite paper comprises 1 wt %-80 wt % matrix. Grammage is the measure of the weight of the antimicrobial composite (e.g., paper, sheet, plastic, or other essentially two-dimensional object) as a function of surface area and is measured by weighing a known area of material. For example, varying the grammage of a material means varying the density of the sheet, the thickness of the sheet, or both. In a non-limiting embodiment, an antimicrobial composite has a grammage from between about 10 g/m² to about 1300 g/m², between about 10 g/m² to about 25 g/m², between about 15 g/m² to about 1300 g/m², between about 15 g/m² to about 30 g/m², between about 15 g/m² to about 50 g/m², between about 15 g/m² to about 80 g/m², between about 15 g/m² to about 100 g/m², between about 25 g/m² to about 1300 g/m², between about 25 g/m² to about 100 g/m², between about 50 g/m² to about 150 g/m², between about 80 g/m² to about 150 g/m², between about 100 g/m² to about 500 g/m², between about 100 g/m² to about 300 g/m², between about 100 g/m² to about 200 g/m², between about 90 g/m² to about 150 g/m², between about 250 g/m² to about 750 g/m², between about 500 g/m² to about 800 g/m², or between about 750 g/m² to about 1300 g/m². In a non-limiting embodiment, an antimicrobial composite paper has a grammage from between about 10 g/m² to about 1300 g/m², between about 10 g/m² to about 25 g/m², between about 15 g/m² to about 1300 g/m², between about 15 g/m² to about 30 g/m², between about 15 g/m² to about 50 g/m², between about 15 g/m² to about 80 g/m², between about 15 g/m² to about 100 g/m², 25 g/m² to about 1300 g/m², between about 25 g/m² to about 100 g/m², between about 50 g/m² to about 150 g/m², between about 80 g/m² to about 150 g/m², between about 100 g/m² to about 500 g/m², between about 100 g/m² to about 300 g/m², between about 100 g/m² to about 200 g/m², between about 90 g/m² to about 150 g/m², between about 250 g/m² to about 750 g/m², between about 500 g/m² to about 800 g/m², or between about 750 g/m² to about 1300 g/m². In an embodiment, an antimicrobial composite paper comprises cellulose. One skilled in the art will appreciate that antimicrobial composite paper may be formed together in a multi-ply or corrugated system to arrive at a packaging insert.

In some embodiments, an antimicrobial composite paper may have a thickness from 0.001-0.05 inches as measured by caliper. In some embodiments, an antimicrobial composite paper may have a thickness of between about 0.01 to about 0.03 inches, or between about 0.01 to about 0.03 inches, or between about 0.01 to about 0.025 inches, or between about 0.02 to about 0.025 inches, or between about 0.022 to about 0.025 inches as measured by caliper. In some embodiments, an antimicrobial composite paper may have a tensile strength from 0.1-10 kg/inch as measured by force required for structural failure utilizing ASTM D828 guidance. In some embodiments, an antimicrobial composite paper may elongate between 0.1-5% of its prepared length during tensile testing. In some embodiments, an antimicrobial composite paper may have an air permeability of 0.1-10 sec/400 cc air, or an air permeability of 1-5 sec/400 cc air, or an air permeability of 2-4 sec/400 cc air, or an air permeability of 3-4 sec/400 cc air, as measured using a Gurley™ densiometer. One skilled in the art will appreciate that antimicrobial composite papers may be prepared via conventional physical paper processing techniques.

The matrix or antimicrobial composite can be stored or transported, for example, in vapor-impermeable packaging. In some embodiments, the matrix or antimicrobial composite may be transported in hermetically sealed packaging. In an embodiment, the matrix is stored or transported in oxygen impermeable packaging. In an embodiment, the antimicrobial composite is stored or transported in water vapor (e.g., water in the gas-phase) impermeable packaging. In an embodiment, the antimicrobial composite is stored or transported in oxygen impermeable packaging. In an embodiment, the matrix is stored or transported in water vapor impermeable packaging.

In an embodiment, the matrix is humidity activated to release antimicrobial. In an embodiment, the antimicrobial composite is humidity activated to release antimicrobial. In an embodiment antimicrobial composite paper is humidity activated to release antimicrobial. In an embodiment, a matrix or antimicrobial composite is considered humidity activated when the release rate of at least one antimicrobial (or representative active volatile) is accelerated as % relative humidity exposed to the matrix or antimicrobial composite, respectively, increases.

In some embodiments, the relative humidity that contacts the matrix or antimicrobial composite and results in humidity activation (e.g., effecting humidity activated release) of the one or more antimicrobials is between about 50% and about 100% relative humidity, or between about 55% and about 100% relative humidity, or between about 60% and about 100% relative humidity, or between about 65% and about 100% relative humidity, or between about 70% and about 100% relative humidity, or between about 75% and 100% relative humidity, or between about 80% and about 100% relative humidity, or between about 85% and about 100% relative humidity, or between about 90% and about 100% relative humidity, or between about 95% and about 100% relative humidity. In some embodiments, the temperature of the water vapor that contacts the matrix or antimicrobial composite and results in humidity activation (e.g., effecting humidity activated release) of the one or more antimicrobials is about −18° C. to about 0° C., −18° C. to about 15° C., −18° C. to about 25° C., −18° C. to about 40° C., about −5° C. to about 15° C., about −1° C. to about 15° C., about 0° C. to about 15° C., or about 5° C. to about 10° C.

These and other aspects will be further appreciated upon consideration of the following Examples, which are intended to illustrate certain particular embodiments of the invention but are not intended to limit its scope, as defined by the claims.

### EXAMPLES

### Matrix Manufacture

One non-limiting example of an illustrative process for manufacturing humidity activated matrices comprising at least one active ingredient is described. Silica gel (in powder form), for example Davisil 633 (60 Å pore diameter, average particle size (in CED of) 37-74 μm, obtainable from Sigma-Aldrich), is placed into a vessel that allows ready mixing of antimicrobial with the silica gel powder. 75 g of clove oil (for example, FCC, FG, containing >80% eugenol, obtainable from Sigma Aldrich) is added to 675 g of silica powder. When adding the clove oil to the silica powder, care is taken to ensure even contact between the clove oil and the silica powder. Even contact between the oil and silica powder may be achieved, for example, by forming a packed bed of the silica powder, placing a single aliquot of the oil at the top of the bed, and allowing the oil to percolate through the bed until all the silica particles are evenly coated. A vertical packed bed may be used for this purpose and a compressed air source may optionally be used to expedite percolation of the oil. This results in a matrix comprising 10 wt % clove oil. The same method is followed with lemongrass oil and vanilla extract in silica powder to result in matrices comprising 10 wt % lemongrass oil (for example, natural, FG, East Indian, Sigma Aldrich) and 10 wt % vanilla extract (for example, 80% ethanol, Cook's Vanilla Extract), respectively. As a skilled artisan will appreciate, the above procedure may be repeated with any essential oil or botanical extract to achieve the same effect. As a skilled artisan will appreciate, different starting weights of the essential oil and delivery material may be used in order to arrive at different essential weight percent in the matrix.

To prepare a mixture of a matrix comprising more than one active ingredient at desired weight percentages, matrices comprising different essential oils at known concentrations may be combined and diluent material may optionally be added. For example, a matrix comprising 3 wt % clove oil, 3 wt % vanilla extract, and 1 wt % lemongrass oil in may be made in the following manner. For every 100 g of matrix, 30 g of 10 wt % clove oil matrix, 30 g of 10 wt % vanilla extract matrix, and 10 g of 10 wt % lemongrass oil matrix are combined with 30 g of silica powder diluent material. This mixture is manually agitated together with a stirring stick, then tumbled in an inverter for 60 minutes to ensure an even, free-flowing combination. The resulting matrix contains 3 wt % clove oil, 3 wt % vanilla extract, and 1 wt % lemongrass oil, for a total active ingredient concentration of 7 wt %. As a skilled artisan will appreciate, different starting weights of the matrices may be used in order to arrive at different essential weight percentages in the final matrix.

### Antimicrobial Composite Manufacture

One non-limiting example of an illustrative process for manufacturing an antimicrobial composite paper comprising antimicrobial is described. The matrix described above comprising 3 wt % clove oil, 3 wt % vanilla extract, and 1 wt % lemongrass oil is dispersed into a cellulose dispersion medium to form an antimicrobial composite paper. The antimicrobial composite paper may be made by dispersing in a batchwise manner cellulose pulp and the matrix in a high percentage of water (for example, >94% wt). As known in conventional paper manufacture, the cellulose pulp is selected to have length and fibrillated characteristics to effectively entrap the matrix and to end up with the necessary sheet character. The mixture of cellulose pulp, matrix, and water is delivered continuously to a headbox which effectively distributes the stock flow in a uniform way on to a moving porous belt. The water is removed in a progressive manner using natural gravity drainage, followed by vacuum that is applied to the underside of the forming belt as is known in conventional paper manufacture. The wet web containing 40-60 wt % water is then conveyed through a pressing section to density the sheet and to further remove water. The wet web is then conveyed into a conventional heat drying section (for example, at >300° F.) where the remaining water is removed. The resulting paper contains <5 wt % water. The antimicrobial composite paper making process is capable of producing sheets having a wide range of design characteristics.

Some non-limiting specific examples of various compositions are provided below.

SAMPLE 1: A matrix material containing 3 wt % clove oil, 3 wt % vanilla extract (80% ethanol, Cook's Vanilla Extract), and 1 wt % lemongrass oil (natural, FG, East Indian, Sigma Aldrich) was prepared in the following manner. To 90 g of silica gel material (Davisil 633, 60 Å pore size, mean particle size (in CED of) 37-74 μm mean circle equivalent diameter particle size, Sigma Aldrich) in a vertical packed bed was added 10 g of clove oil (FCC, FG, >80% eugenol, Sigma Aldrich) in a single aliquot at the top of the packed bed. This produces a matrix having 10 wt % clove oil. The same procedure was followed to prepare a matrix having 10 wt % vanilla extract (80% ethanol, Cook's Vanilla Extract) and a matrix having 10 wt % lemongrass oil (natural, FG, East Indian, Sigma Aldrich). 30g of 10 wt % clove oil matrix, 30 g of 10 wt % vanilla extract matrix, and 10 g 10 wt % of lemongrass oil matrix were mixed with an additional 30 g of silica gel to prepare 100 g of matrix. The matrices comprising the different essential oils were first manually mixed. The mixture was then placed in a jar and tumbled in an inverter for 60 minutes. The resulting material contained 3 wt % clove oil, 3 wt % vanilla extract, and 1 wt % lemongrass oil, for a total of 7 wt % essential oil antimicrobials.

SAMPLE 2: An antimicrobial composite paper containing the matrix of Sample 1 was prepared by incorporating Sample 1 into a cellulosic fiber material. The paper was prepared by mixing 50% cellulosic fiber and 50% Sample 1 by weight in a water bath (>94% wt of the combination of Sample 1 and cellulosic fiber). The mixture of cellulosic fiber and Sample 1 was extruded and dried on a roll-to-roll processer at a temperature of 300° F. The final material contained 6.2 g of matrix per 12×12″ sheet of paper, or a total grammage of approximately 118.3 g/m².

SAMPLE 3: A matrix material containing 13 wt % clove oil was prepared in the following manner. To 25 kg of silica gel material (Silicycle, 60 Å pore size, mean particle size (in CED of) 20-45 μm, in a drum was added 3.2 kg of clove oil (FCC, FG, Lebermuth) over the course of 10 minutes at the top of the drum. The mixture was then tumbled in a mixer for 30 minutes. The resulting matrix material contained 13 wt % clove oil.

SAMPLE 4: An antimicrobial composite paper containing the matrix of Sample 3 was prepared by incorporating Sample 3 into a cellulosic fiber dispersion medium. The paper was prepared by mixing 58% cellulosic fiber dispersion medium and 42% Sample 3 by weight in a water bath (>94% wt of the combination of Sample 3 and cellulosic fiber). The mixture of cellulosic fiber and Sample 3 was extruded and dried on a roll-to-roll processer at a temperature of 300° F. The final material contained 6.6 g of matrix per 12×12″ sheet of antimicrobial composite paper, or a total grammage of approximately 196 g/m². The antimicrobial composite paper of Sample 4 comprised 0.096 wt % antimicrobial and 38 wt % delivery material (i.e. Sample 3).

SAMPLE 5: An antimicrobial composite paper containing a matrix prepared by the same method as Sample 3 using a larger silica gel material (Silicycle, 60 Å pore size, mean particle size (in CED of) 40-63 μm mean circle equivalent diameter particle size) was prepared by incorporating this matrix into a cellulosic fiber material. The paper was prepared by mixing 58% cellulosic fiber and 42% matrix by weight in a water bath (>94% wt of the combination of matrix and cellulosic fiber). The mixture of cellulosic fiber and Sample 3 was extruded and dried on a roll-to-roll processer at a temperature of 300° F. The final antimicrobial composite material contained 6.2 g of matrix per 12×12″ sheet of antimicrobial composite paper, or a total grammage of approximately 186 g/m². The antimicrobial composite paper of Sample 5 comprised 0.013 wt % antimicrobial and 38 wt % delivery material (i.e. Sample 3).

Release Test from Sample 1—Antimicrobial Release Rate, 75% Relative Humidity.

The release of antimicrobial from Sample 1 was determined using headspace analysis of sealed vials containing 50 mg of the Sample 1, as measured with a gas chromatograph (GC) equipped with a flame ionization detector. The matrix was placed in a small vial (e.g., a 2-dram vial), the small vial then nested in a larger vial (e.g., 10 mL amber vial). A solution corresponding to 75% relative humidity at 21° C. was loaded into the larger vial via pipette so that the matrix was kept from direct water contact. A screw-cap with a TEFLON™ liner was screwed onto the larger vial, the vial sealed with paraffin wax to prevent leakage. In this experiment, “hour zero” was defined as the instant the vial cap was closed after the solution was loaded into the larger vial. The GC oven temperature was set to 200° C. The area of the GC peak for eugenol was calibrated by comparison to known areas of an authentic eugenol standard (99%, Sigma Aldrich) to determine antimicrobial release. During the release experiments, the samples were stored at 21° C. at atmospheric pressure.

The release rate over 48 hours at 75% relative humidity is given below in Table 4. Release rate was calculated according to the method discussed previously for release tests for measuring humidity response characteristics of matrices. While multiple antimicrobials were detected as emerging from Sample 1, release of antimicrobial from the material is reported as a function of relevant active volatile eugenol. The release of eugenol from Sample 1 was calibrated using known quantities of eugenol injected into the instrument with the same protocol.

TABLE 4
Antimicrobial Release Rates from Sample 1 at 75%
relative humidity over 48 hours.

| | Rate of Antimicrobial Release |
|---|---|
| Time (hrs) | (mol/g matrix/hr) |
| 1.5 | 6.944E−11 |
| 5 | 6.068E−11 |
| 24.5 | 8.121E−11 |
| 48 | 8.986E−11 |

Release Test from Sample 2—Release Reported as a Rate, Using Different Relative Humidities.

The release of antimicrobial from Sample 2 was determined using headspace analysis of sealed vials containing 150 mg of the Sample 2, as measured with a gas chromatograph (GC) equipped with a flame ionization detector. The antimicrobial composite was placed in a small vial (e.g., a 2-dram vial), the small vial then nested in a larger vial (e.g., 10 mL amber vial). Four different release tests were conducted for each relevant active volatile measured via GC using separate vials assembled as above: 1. a solution corresponding to 15% relative humidity at 21° C. was loaded into the larger vial via pipette, 2. a solution corresponding to 33% relative humidity at 21° C. was loaded into the larger vial via pipette, 3. a solution corresponding to 75% relative humidity at 21° C. was loaded into the larger vial via pipette, 4. solution corresponding to 99% relative humidity at 21° C. was loaded into the larger vial via pipette, each solution loaded so that the antimicrobial composite paper was kept from direct water contact. A screw-cap with a TEFLON™ liner was screwed onto the larger vial, the vial sealed with paraffin wax to prevent leakage. In this experiment, “hour zero” was defined as the instant the vial cap was closed after the solution was loaded into the larger vial. The GC oven temperature was set to 200° C. The area of the GC peak for eugenyl acetate was calibrated using known methods by comparison to known areas of an authentic eugenol standard (99%, Sigma Aldrich) in combination with the effective carbon number concept (Scanlon and Willis, 1985) to determine antimicrobial release. During the release experiments, the samples were stored at 21° C. at atmospheric pressure.

The release rate over 48 hours at each different relative humidity is given below in Tables 5-8. Release rate was calculated according to the method discussed previously for release tests for measuring humidity response characteristics of antimicrobial composites. While multiple antimicrobials were detected as emerging from Sample 2, release of antimicrobial from the material is reported as a function of relevant active volatile eugenyl acetate.

TABLE 5
Antimicrobial Release Rates from Sample 2 at 15%
relative humidity over 48 hours.

| | Rate of Antimicrobial Release |
|---|---|
| Time (hrs) | (mol/g matrix/hr) |
| 1.5 | 9.597E−13 |
| 5 | nil |
| 24.5 | nil |
| 48 | 1.014E−14 |

TABLE 6
Antimicrobial Release Rates from Sample 2 at 33%
relative humidity over 48 hours.

| | Rate of Antimicrobial Release |
|---|---|
| Time (hrs) | (mol/g matrix/hr) |
| 1.5 | 1.090E−12 |
| 5 | nil |
| 24.5 | nil |
| 48 | nil |

TABLE 7
Antimicrobial Release Rates from Sample 2 at 75%
relative humidity over 48 hours.

| | Rate of Antimicrobial Release |
|---|---|
| Time (hrs) | (mol/g matrix/hr) |
| 1.5 | 1.654E−12 |
| 5 | 2.819E−13 |
| 24.5 | 2.257E−13 |
| 48 | 2.081E−13 |

TABLE 8
Antimicrobial Release Rates from Sample 2 at 99%
relative humidity over 48 hours.

| | Rate of Antimicrobial Release |
|---|---|
| Time (hrs) | (mol/g matrix/hr) |
| 1.5 | 1.099E−12 |
| 5 | 2.403E−13 |
| 24.5 | 2.612E−13 |
| 48 | 5.617E−13 |

From at least these experiments it is clear that paper samples are humidity activated to effect antimicrobial release. For example, at hour 24.5, the release rate of antimicrobial increases as % relative humidity increases.

Produce Efficacy Test from Sample 2—Reduction of Disease In Vivo in Clamshell-Packed Raspberries

A study was conducted on in clamshell-packed raspberries to study the effect of release of essential oils from Sample 2 on produce. Commercial raspberries were obtained from the Chicago terminal market, having been packed in standard 8 oz. clamshells in Wastonville, Calif. four days prior. Prior to the start of the experiment, all clamshells already showing visible signs of disease were exchanged with fresh clamshells from another packout to eliminate potential bias in the fungal incidence. To further eliminate bias in the flats, all clamshells were removed prior to the start of the experiment and were randomized between all flats.

For the treated sets of raspberries, either 1 or 2 sheets of Sample 2 paper were placed in the bottom of the clamshell, with the raspberries on top of the paper. In each of the treatment sets, T1 (1 sheet of Sample 2) and T2 (2 sheets of Sample 2), of 5 flats of raspberries, each containing 12 treated clamshells were studied. Control (untreated) raspberries clamshells did not contain the antimicrobial composite paper. In the control set, 5 flats of raspberries, each containing 12 clamshells, were studied.

During the efficacy test, raspberries were held at 34° F. and 99% relative humidity for 7 days followed by 44° F. and 86% relative humidity for 2 days. Each clamshell was individually inspected on each of the 6 faces by a technician. Each clamshell was opened. No berries were directly touched or handled. Any visible fungus was indicated as a FAIL. Clamshells with no fungus were indicated as PASS. On day 8, T1 indicated a 12% decrease in the number of infected (Failed) clamshells relative to the untreated control, and T2 indicated a 20% decrease in the number of infected (Failed) clamshells relative to the untreated control. From at least these results, antimicrobial release via the humidity activated paper of Sample 2 is sufficient to reduce the proliferation of disease in commercially packed raspberries.

On day 8, approximately 750 berries were counted from each sample set, representing two complete flats of berries. Table 9 below shows the average number of infected berries per clamshell.

TABLE 9
Individual Raspberry Count Results from Day 8

| | Average Number of Infected |
|---|---|
| Group | Berries per Clamshell |
| Untreated Control | 9 |
| T1 | 6 |
| T2 | 4 |

From at least Table 9 it is shown that the rate of infection on a per clamshell basis is reduced by 33% upon application of Sample 2 at the T1 level and 56% upon application of Sample 2 at the T2 level.

Produce Efficacy Test from Sample 4—Reduction of Disease In Vivo in Clamshell-Packed Raspberries

A study was conducted on in clamshell-packed raspberries to study the effect of release of essential oils from Sample 4 on produce. Commercial raspberries were obtained from the Chicago terminal market, having been packed in standard 8 oz. clamshells in Mexico seven days prior. Prior to the start of the experiment, all clamshells already showing visible signs of disease were exchanged with fresh clamshells from another packout to eliminate potential bias in the fungal incidence. To further eliminate bias in the flats, all clamshells were removed prior to the start of the experiment and were randomized between all flats.

For the treated sets of raspberries 1 sheet of Sample 4 antimicrobial composite was placed on top of the raspberries inside of the clamshell. This was done to avoid damaging berries. In each of the treatment sets, 5 flats of raspberries, each containing 12 treated clamshells were studied. Control (untreated) raspberries clamshells did not contain the Sample 4 antimicrobial composite. In the control set, 5 flats of raspberries, each containing 12 clamshells, were studied.

During the efficacy test, raspberries were held at 34° F. and 99% relative humidity for 8 days. Each clamshell was individually inspected on each of the 6 faces by a technician. Each clamshell was opened. No berries were directly touched or handled. Any visible fungus was indicated as a FAIL. Clamshells with no fungus were indicated as PASS. On day 8, Sample 4 indicated a 40% decrease in the number of infected (Failed) clamshells relative to the untreated control. From at least these results, antimicrobial release via the humidity activated paper of Sample 4 is sufficient to reduce the proliferation of disease in commercially packed raspberries.

TABLE 10
Clamshell Raspberry Count Results from Day 8

| Group | # of infected clamshells |
|---|---|
| Untreated Control | 5 |
| Sample 4 | 3 |

On day 8, approximately 350 berries were counted from each sample set, representing 1 complete flat of berries. Table 11 below shows the percentage of infected berries per test condition.

TABLE 11
Individual Raspberry Count Results from Day 8

| Group | % of Infected Berries |
|---|---|
| Untreated Control | 3.3 |
| Sample 4 | 1.5 |

From at least Table 11 it is shown that the rate of infection is reduced by 56% upon application of Sample 4.

Produce Efficacy Test from Sample 5—Reduction of Disease In Vivo in Clamshell-Packed Raspberries

A study was conducted on in clamshell-packed raspberries to study the effect of release of essential oils from Sample 5 on produce. Commercial raspberries were obtained from the Chicago terminal market, having been packed in standard 8 oz. clamshells in Mexico seven days prior. Prior to the start of the experiment, all clamshells already showing visible signs of disease were exchanged with fresh clamshells from another packout to eliminate potential bias in the fungal incidence. To further eliminate bias in the flats, all clamshells were removed prior to the start of the experiment and were randomized between all flats.

For the treated sets of raspberries 1 sheet of Sample 5 paper was placed on top of the raspberries inside of the clamshell. This was done to avoid damaging berries. In each of the treatment sets, 5 flats of raspberries, each containing 12 treated clamshells were studied. Control (untreated) raspberries clamshells did not contain the antimicrobial composite paper. In the control set, 5 flats of raspberries, each containing 12 clamshells, were studied.

During the efficacy test, raspberries were held at 34° F. and 99% relative humidity for 8 days. On day 8, approximately 350 berries were counted from each sample set, representing 1 complete flat of berries. Table 12 below shows the percentage of infected berries per test condition.

TABLE 12
Individual Raspberry Count Results from Day 8

| Group | % of Infected Berries |
|---|---|
| Untreated Control | 3.3 |
| Sample 5 | 3.0 |

From at least Table 12 it is shown that the rate of infection is reduced by 10.6% upon application of Sample 5.

The efficacy test results presented above indicate the commercial relevance of the performance of humidity activated antimicrobial composites as discussed herein.

An advantage of the compositions disclosed herein is that they are humidity activated, which allows for easy storage of the matrix or antimicrobial composite in a passive state, for example, inside non-vapor or non-water-transmissive packaging. Upon opening the stored materials and deploying them in a commercial context, the standard storage conditions of berries, for example, and the water coming from the berries through respiration can result in the humidity activation of the matrix and/or antimicrobial composite, thus reducing the labor costs and enhancing ease of use in a commercial context. Packaging inserts comprising the antimicrobial composite can be easily integrated into berry clamshells and other food product packaging. In an embodiment, the antimicrobials are organic certified.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1-134. (canceled)

135. An antimicrobial composite, comprising:
a composition comprising:
silica; and
antimicrobial; and
a dispersion medium in which the composition is dispersed,
wherein the antimicrobial is present in an amount of at least about 0.001 wt % versus the total weight of the antimicrobial composite, and
wherein the antimicrobial is associated with the silica such that when humidity is introduced to the composition, at least a portion of the antimicrobial is released from the composition.

136. A packaging insert comprising the antimicrobial composite of claim 135.

137. A package, comprising the packaging insert of claim 136.

138. The package of claim 137, further comprising produce.

139. The package of claim 137, further comprising berries.

140. The antimicrobial composite of claim 135, wherein the antimicrobial composite comprises a polyethylene film.

141. The antimicrobial composite of claim 135, wherein the dispersion medium comprises a polymeric material.

142. The antimicrobial composite of claim 141, wherein the polymeric material comprises cellulose.

143. The antimicrobial composite of claim 135, wherein the antimicrobial composite comprises at least one of a paper, film, or plastic.

144. The packaging insert of claim 136, further comprising one or more of a water-absorbent layer, an adhesive layer, and a water-permeable material.

145. The antimicrobial composite of claim 135, wherein the silica is a porous solid.

146. The antimicrobial composite of claim 135, wherein the antimicrobial comprises an essential oil.

147. The antimicrobial composite of claim 135, wherein the antimicrobial comprises one or more of clove oil, clove extract, vanilla extract, and lemongrass oil.

148. The antimicrobial composite of claim 135, wherein the silica has a surface area in a range of about 50 to about 1500 m²/g.

149. The antimicrobial composite of claim 135, wherein the silica has an average pore diameter in a range of about 5 Å to about 100 Å.

150. The antimicrobial composite of claim 135, wherein the silica has an internal void volume in a range of about 0.1 mL/g to about 1.5 mL/g.

151. The antimicrobial composite of claim 135, wherein the composition has an average particle size in circle equivalent diameter (CED) in a range of about 5 μm to about 250 μm.

152. The antimicrobial composite of claim 135, wherein the antimicrobial composite has a grammage in a range of about 10 g/m² to about 1300 g/m².

153. The antimicrobial composite of claim 135, wherein the silica comprises at least one of amorphous silica, fumed silica, particulate silica, ground quartz, particulate, fumed, crystalline, and ground silicon dioxide and associated derivatives, and combinations thereof.

154. The antimicrobial composite of claim 135, wherein the antimicrobial is present in the silica in an amount in a range of about 0.001 wt % to about 20 wt % versus the total weight of the silica and the antimicrobial.

155. The antimicrobial composite of claim 135, wherein the dispersion medium is present in the antimicrobial composite in an amount of at least about 50 wt % versus the total weight of the dispersion medium and the composition.

156. The antimicrobial composite of claim 135, wherein the antimicrobial comprises at least one of a terpene, a terpenoid, a phenol, a phenolic compound, thymol, curcumin, carvacrol, bay leaf oil, lemongrass oil, peppermint oil, spearmint oil, oil of winter green, acacia oil, eucalyptol, limonene, eugenol, menthol, farnesol, carvone, hexanal, thyme oil, dill oil, oregano oil, neem oil, orange peel oil, lemon peel oil, rosemary oil, cumin seed extract, thyme oil, hexanal, thymol, eugenol, and eugenyl acetate, clove oil, clove extract, vanilla oil, vanilla extract, citronellal, and vanillin, curcumin, methyl salicylate, and methyl jasmonate or its derivatives.

157. A method, comprising:
exposing an antimicrobial composite comprising an antimicrobial to humidity such that the antimicrobial is released from the antimicrobial composite, wherein the antimicrobial composite comprises:
a dispersion medium; and
a silica-based delivery material dispersed in the dispersion medium, wherein the antimicrobial is stored in the silica-based delivery material prior to release.
